(19) United States
(12) Patent Application Publication
(10) Pub. No.: US 2022/0341105 A1
(43) Pub. Date: Oct. 27, 2022

(54) CHISEL HOLDER SYSTEM, MILLING DRUM AND GROUND MILLING MACHINE

(71) Applicant: BOMAG GmbH, Boppard (DE)

(72) Inventors: Steffen Wachsmann, Boppard (DE); Monica Wolf, Boppard (DE)

(21) Appl. No.: 17/617,064

(22) PCT Filed: Jun. 26, 2020
(86) PCT No.: PCT/EP2020/000121

§ 371 Date: Dec. 7, 2021

(30) Foreign Application Priority Data
Jun. 28, 2019 (DE) 10 2019 004 558.0
Nov. 22, 2019 (DE) 10 2019 008 156.0

(51) Int. Cl. E01C 23/088; B28D 1/18

(52) U.S. Cl. CPC E01C 23/088; B28D 1/188

(57) ABSTRACT

The present invention relates to a chisel holder system comprising a milling chisel, a chisel holder and a clamping device, in particular a clamping screw. The present invention further relates to a milling drum and a ground milling machine having a chisel holder system.

### CROSS-REFERENCE TO RELATED APPLICATION

The present application is a U.S. National Stage entry under 35 U.S.C. § 371 of, and claims priority to, International Application No. PCT/EP2020/000121, filed Jun. 26, 2020, which claims priority to German Application No. 102019004558.0, filed Jun. 28, 2019 and to German Application No. 102019008156.0, filed Nov. 22, 2019, the disclosures of which are hereby incorporated herein by reference in their entireties.

### FIELD OF THE INVENTION

The present invention relates to a chisel holder system, a milling drum and a ground milling machine.

### BACKGROUND OF THE INVENTION

Milling chisels and chisel holder systems are also used in particular for milling road markings and road pavements, especially asphalt pavements, as part of road rehabilitation measures. So-called ground milling machines, in particular road cold milling machines, are used for this purpose. These usually comprise a milling drum equipped with milling chisels, which in working operation is lowered onto the underlying ground to be milled with its rotation axis running horizontally and transversely to the working direction of the ground milling machine. Such a ground milling machine with such a milling drum is described, for example, in DE102012022879A1, which is hereby incorporated herein by reference.

The milling drum is usually equipped with milling chisels by means of so-called chisel holders configured to receive and support the milling chisels on the milling drum. The chisel holder, which is fastened directly or indirectly to the outer circumferential surface of a support tube of the milling drum, and the milling chisel, which is held in the chisel holder, in particular directly, together form the chisel holder system. These chisel holders may be connected directly to a support tube of the milling drum or may be configured as so-called quick-change tool holders, which in turn are mounted on a base part connected to the support tube of the milling drum.

In the prior art, a variety of milling chisels and chisel holders are described, including a group of milling chisels rotatably mounted in the chisel holder and a group of milling chisels non-rotatably mounted in the chisel holder.

The present invention relates to the configuration of a milling chisel and a chisel holder or chisel holder system, which are provided in particular for non-rotatable mounting of the milling chisel. A non-rotatable, in particular direct, mounting of the milling chisel in the chisel holder has the advantage on the one hand that wear phenomena that occur on the chisel holder due to a relative movement of the milling chisel are reduced or eliminated. On the other hand, in addition to milling chisels with hard metal tips, milling chisels with so-called PCD (polycrystalline diamond) tips are increasingly being used. Such chisel tips are characterized by their considerable resistance to wear and thus significantly extended tool life compared to conventional milling chisels. For such milling chisels in particular, it is contemplated to mount them in the chisel holder in a non-rotatable manner in order to reduce wear between the milling chisel and the chisel holder and to be able, for example, to even realize non-rotationally symmetrical tip shapes for milling chisels.

WO 2014033227 A2 discloses a holder system in which a chisel tip holding body can be fixed in a non-rotatable manner via a frictional connection using a fastening screw which can be unscrewed from the rear along the longitudinal axis relative to the chisel tip. WO 2014072345 A1 discloses a milling chisel with a quick-change tool holder that is fixed by means of a set screw that can be screwed into another quick-change tool holder at an angle to the longitudinal axis of the quick-change tool holder. One disadvantage of these systems is that they must be partially accessible from the rear to loosen a fastening screw, which is particularly disadvantageous when a milling drum is closely fitted with milling chisels, as is the case with fine milling drums, for example. On the other hand, the force transfer from the milling chisel to the chisel holder can still be optimized to some extent.

Against this background, it is therefore an aspect of the present invention to provide a way in which the known milling chisels and chisel holders of a chisel holder system can be further optimized, in particular with regard to their use on fine milling drums and, at the same time, with regard to an easier assembly and disassembly process.

### SUMMARY OF THE INVENTION

Further inventions, taking into account the present overall disclosure, lie in the special configuration of the milling chisel for a ground milling machine, in the special configuration of an assembly unit with such a milling chisel and a clamping screw, in the special configuration of the chisel holder, in the configuration of the milling chisel together with a chisel rotating tool, and in a method for installing a milling chisel in a chisel holder, as respectively described below.

The chisel holder system according to the present invention comprises a milling chisel, a chisel holder and a clamping device, in particular a clamping screw. The chisel holder is configured to at least partially accommodate the milling chisel. The clamping device serves to fix the milling chisel in the chisel holder in a defined relative position with respect to the chisel holder and in a releasable and in particular non-rotatable manner, which is ideally achieved by applying a clamping force acting on the milling chisel positioned in the chisel holder by tightening the clamping device.

According to the present invention, the milling chisel comprises a chisel head with a chisel tip, the chisel head widening in a head region away from the chisel tip along a longitudinal axis of the milling chisel in a radial direction with respect to said longitudinal axis, a contact region adjoining the head region, in particular directly, and configured to contact the chisel holder, a shank region adjoining the contact region, in particular directly, and a clamping region adjoining the shank region, in particular directly.

In the clamping region, the milling chisel has at least one clamping wedge with a chisel holder contact surface and/or two shank legs which are spaced apart from each other in the radial direction relative to the longitudinal axis of the milling chisel via a clamping slot, or an inclined sliding surface against which the clamping device, in particular the clamping screw, rests, and/or a guide recess engaged by the clamping screw. For the clamping wedge of the milling chisel, it is essential that it is provided in particular for direct contact with the chisel holder, in particular in its interior. With regard to the clamping slot, it is important that it allows in particular the two shank legs to bend apart from each other, resulting in fixing of the milling chisel in the chisel holder. For the inclined sliding surface and/or the guide recess in the clamping region of the milling chisel, it is particularly advantageous if, in cooperation with the clamping device, particularly when the clamping device is tightened, they trigger a pulling effect on the milling chisel in its direction of insertion into the chisel holder, i.e., cause a tensile force in this direction. Further details on this are described below.

A further component of the chisel holder system according to the present invention is the chisel holder, which is configured to directly receive the milling chisel such that the milling chisel can be mounted in the chisel holder in a detachable and replaceable manner or is mounted in an installed state. The chisel holder may be attached directly to a support tube of a milling drum or may in turn be mounted indirectly, in the form of a so-called quick-change tool holder, on a base part in a replaceable manner. The chisel holder is essentially configured as a holder sleeve and comprises an end face-side milling chisel receiving opening, a shank receiving space adjoining the milling chisel receiving opening in the direction of an insertion axis of the milling chisel and extending into the interior of the holder sleeve, and a clamping means opening extending transversely to the insertion axis of the shank receptacle, which provides an access connection from the outer side of the holder sleeve surrounding the insertion axis to the shank receiving space and through which the clamping device can be inserted for fixing the milling chisel within the chisel holder.

Details particularly on the chisel holder system according to an exemplary embodiment of the present invention and in particular also on the milling chisel and the chisel holder, together with respectively modified embodiments, are described in more detail below.

The tip of the milling chisel refers to the pointed tip or head region of the milling chisel that impinges on the ground to be milled during the milling process. This chisel tip is preferably made of hard metal or, in particular, a PCD material. The chisel tip may be part of or attached to a hood element or chisel cap, such as a wear protection cap, for example by brazing or the like. Inside, the chisel head may partially comprise a part of a chisel base body, for example, consisting of a steel material, in particular quenched and tempered steel. The chisel head with the chisel tip usually widens along a longitudinal axis of the milling chisel away from the chisel tip, i.e., against a cutting direction, in a radial direction with respect to said longitudinal axis. The chisel head may thus have an essentially conical overall structure, for example.

In the longitudinal direction away from the chisel tip, the head region described above is adjoined, in particular directly, by a contact region of the milling chisel, which is configured for contact with a chisel holder. The contact region of the milling chisel is thus provided to contact a chisel holder in the installed state, i.e., when the milling chisel is seated in a chisel holder, in particular directly, and to dissipate forces introduced into the chisel tip of the milling chisel, for example, due to the ongoing milling process, via this region into the chisel holder and via the latter ultimately into the milling drum. The contact region may be formed by the chisel base body. The contact region of the milling chisel may, for example, extend to the radial edge of the chisel holder as seen in the radial direction relative to the insertion axis of the milling chisel and/or its longitudinal axis, and/or may even overlap it.

In the direction of the longitudinal axis of the milling chisel away from the chisel tip, the contact region is adjoined, in particular directly, by a shank region. In the shank region, the milling chisel may be longitudinally elongated, for example cylindrical. The purpose of the shank region is to connect the contact region to a clamping region described in more detail below. The shank region may be likewise formed by the chisel base body of the milling chisel. The shank region may also be larger or smaller with respect to its extension in the direction of the longitudinal axis of the milling chisel. It may even be formed at least partially overlapping with the contact region.

Along the longitudinal axis of the milling chisel in the direction away from the chisel tip, the shank region is followed, in particular directly, by the clamping region, said clamping region of the milling chisel having, according to one embodiment of the present invention, for example, at least one clamping wedge with a chisel holder contact surface. Additionally or alternatively, the clamping region of the milling chisel has, according to one embodiment of the present invention, in particular exactly or exclusively, two shank legs which are spaced apart from each other in the radial direction relative to the longitudinal axis of the milling chisel via a clamping slot, or an inclined sliding surface contacted by the clamping device, in particular the clamping screw, and/or a guide recess engaged by the clamping screw. The clamping region thus has a function in fixing the milling chisel in a chisel holder in a non-rotatable manner and at the same time in securing it axially, in particular also in cooperation with the clamping device. The clamping region is configured such that it can be used to clamp the milling chisel in a chisel holder in a non-rotatable manner.

One aspect of a configuration variant of the milling chisel according to the present invention now is that the clamping wedge having a chisel holder contact surface is provided in the clamping region. The clamping wedge is characterized by the fact that it comprises a contact surface extending at an angle to the longitudinal axis in a radially outward direction, said contact surface forming the outer surface of a wedge. The contact surface is thus configured such that it increases in radial direction in the direction of the longitudinal axis of the milling chisel away from the chisel tip, i.e., with respect to the working direction of the milling chisel toward the rear. The contact surface thus forms a contact region sloping forward in the direction of the longitudinal axis toward the chisel tip body, which is provided for fixing contact with a chisel holder described in more detail below.

In addition or as an alternative to the clamping wedge, the milling chisel may also have at least one inclined sliding surface and/or guide recess in the clamping region, in particular in the region of the milling chisel shank and especially in the region of the shank legs. These may be configured and provided for at least partial engagement with the clamping means, which can be inserted into the chisel holder, in particular from outside the chisel holder. The purpose of the inclined sliding surface and/or the guide recess is in particular to apply a clamping force to the clamping region in cooperation with the clamping means, in particular a tensile force in the direction of insertion of the milling chisel into the chisel holder. For this purpose, the clamping means, in cooperation with the inclined sliding surface and/or the guide recess, forms a type of straight-wedge mechanism in which, with the aid of a wedge-shaped sliding surface, the direction of insertion or direction of action of the clamping means, which ideally runs almost perpendicular to the direction of insertion of the milling chisel, is converted into an insertion movement of the milling chisel in the direction of its axis of insertion into the chisel holder.

The inclined sliding surface is thus characterized in particular by the fact that it extends in the milling chisel at an angle or obliquely to the insertion axis of the milling chisel, i.e., intersecting it, and that during the clamping process the clamping device slides along it, in particular in a direction essentially perpendicular to the direction of insertion of the milling chisel into the chisel holder. The guide recess is characterized in particular by the fact that it is a recess in the chisel shank, in particular in the form of a through opening running perpendicular to the insertion or longitudinal axis of the milling chisel in the otherwise solid and essentially cylindrical chisel shank according to one embodiment. The inclined sliding surface of the milling chisel may be formed by the guide recess itself. For this purpose, the guide recess may in particular have a hollow cone-shaped inner circumferential surface, the longitudinal axis of the cone running perpendicular to the longitudinal axis of the milling chisel.

In the manufacturing process, the milling chisel as a whole may be made up of several individual components and, for example, in addition to a PCD chisel tip (boron nitride may also be used as an alternative), may have a wear protection cap or chisel cap, in particular made of a hard metal, very particularly with a Vickers hardness in the range from 1100 to 1600 HV, and a chisel base body, in particular made of a quenched and tempered steel, forming part of the chisel head, the contact region, the shank region and the clamping region. In accordance with one embodiment of the present invention, components of the chisel cap are tungsten carbide and/or cobalt. It is essential that the individual components forming the milling chisel in its entirety are firmly and inseparably connected to one another, for example by soldering, welding and/or gluing, and in this way form a firmly connected component assembly which in its entirety forms the milling chisel.

The clamping wedge may have a greater radial extension relative to the longitudinal axis of the milling chisel than the shank region adjacent to the clamping wedge. In this embodiment, the clamping wedge thus protrudes radially beyond the shank region. In this manner, it is possible to achieve a contact between the milling chisel and a chisel holder with particularly high load-bearing capacity, as will be described in more detail below.

Generally, the specific configuration of the contact region may vary. It is advantageous if the contact region at least partially has a contact cone tapering radially in a direction away from the chisel tip, the contact cone being configured in particular as a truncated cone. In this embodiment, the contact region thus becomes smaller in diameter in a rearward direction away from the chisel tip. This provides a relatively large contact surface for contact of the milling chisel with a chisel holder, which overall enables optimized force transmission between the milling chisel and the chisel holder. It is ideal if the contact cone at least partially has a linear and oblique circumferential surface line directed toward the longitudinal axis of the milling chisel (the circumferential surface line refers to the shape of the outer shell in a plane in which the cone axis of the contact cone also runs), although curved and/or stepped variants may also be included additionally or alternatively. When virtually extended, the linear part of the circumferential surface line, in particular of a contact cone which is preferably completely formed as a cone with a linear circumferential surface line, preferably intersects the longitudinal axis of the milling chisel in an angular range of greater than 5°, in particular greater than 10° and less than 50°, very particularly less than 30°.

The at least one clamping wedge of the milling chisel may be arranged terminally in the longitudinal direction of the milling chisel. The clamping wedge thus forms the end of the milling chisel or at least an end region in the direction away from the chisel tip. This allows a relatively compact configuration of the milling chisel and at the same time optimized clamping possibilities, as further discussed below. In addition to the contact surface or wedge surface formed by the clamping wedge for contact with a chisel holder, the clamping wedge also includes a part of the milling chisel that, if present, projects radially beyond the shank region in the direction away from the chisel tip behind the chisel holder contact surface.

The at least one clamping wedge thus comprises a contact surface running obliquely to the longitudinal axis of the milling chisel, with the distance of the contact surface in the radial direction relative to the longitudinal axis of the milling chisel increasing in the direction away from the tip of the milling chisel. This contact surface thus is counter-directional with respect to the contact cone. When viewed in a direction away from the chisel tip, the milling chisel thus tapers in relation to its longitudinal axis in the contact region or in the region of the contact cone and then widens again at least partially in the region of the clamping wedge. The contact surface of the clamping wedge in this case preferably runs at an angle of 20° to 70°, particularly 35° to 55°, to the longitudinal axis of the milling chisel. Irrespective of this, the contact surface of the clamping wedge preferably runs steeper relative to the longitudinal axis of the milling chisel than any existing oblique contact surface in the contact region. The contact surface of the clamping wedge may be used to tighten the milling chisel within a chisel holder, as described in more detail below.

According to one embodiment, the milling chisel comprises, especially exclusively, two clamping wedges positioned opposite each other in the radial direction. In this embodiment example, the two clamping wedges are arranged separately and spaced from each other in radial direction relative to the longitudinal axis of the milling chisel. The use of several, in particular exactly two, clamping wedges is advantageous in that it allows simultaneous clamping of the milling chisel with the aid of several contact surfaces lying opposite each other in the radial direction relative to the longitudinal axis of the milling chisel, so that a total clamping force can be generated at several points distributed around the longitudinal axis of the milling chisel and thus distributed around the longitudinal axis.

Generally, different configurations of clamping wedges may be realized on a milling chisel. Particularly with regard to the manufacturing and assembly process, however, it is advantageous if the two clamping wedges are mirror-symmetrical to each other with respect to a mirror plane running in the direction of the longitudinal axis of the milling chisel.

One aspect of this milling chisel according to the present invention is that it can be fixed in a chisel holder with the aid of the at least one clamping wedge and can in particular be clamped directly to the chisel holder. This can be achieved particularly easily if the milling chisel has two shank legs in the clamping region, as described in more detail below.

Additionally or alternatively, a further, independent approach of the present invention, in particular also as part of a chisel holder system according to the present invention, relates to a milling chisel for a ground milling machine, comprising a chisel head with a chisel tip, the chisel head widening in a head region against a milling direction or away from the chisel tip along a longitudinal axis of the milling chisel in the radial direction relative to said longitudinal axis, a contact region, in particular conical, adjoining the head region, in particular directly, and configured for contact with a chisel holder, a shank region adjoining the contact region, in particular directly, a clamping region adjoining the shank region, in particular directly, and/or at least partially formed by the shank region, the milling chisel having in the shank region, for example, at least two shank legs which are spaced apart from one another in the radial direction with respect to the longitudinal axis of the milling chisel via a clamping slot. This variant does not necessarily require the use of a clamping wedge on the chisel shank. Additionally or alternatively, a conical through hole and/or a conical clamping screw, i.e., the above-described inclined sliding surface and/or guide recess in or on the chisel shank, may be used to convert a screwing-in force of the clamping screw into a tensile force acting on the milling chisel when the clamping screw is screwed in, which is achieved via contact surfaces between the clamping screw and the milling chisel, in particular the chisel shank, which run in a wedge shape relative to one another. Optionally, shank legs may additionally be used for this purpose. With this solution, the chisel shank does not have any radial enlargement in the form of clamping wedges toward the end of the chisel.

Irrespective of the use of a clamping wedge, the use of two shank legs spaced apart from each other in the radial direction relative to the longitudinal axis of the milling chisel, which are spaced apart from each other in the radial direction relative to the longitudinal axis of the milling chisel via the clamping slot, results in the possibility of spreading apart the shank legs for fastening in a chisel holder and thereby clamping them in a chisel holder, in particular via a frictional connection. In this manner, the milling chisel is no longer solid in the clamping region, but comprises two spaced shank legs that are radially spaced from each other relative to the longitudinal axis of the milling chisel via a recess in the form of a clamping slot. This specific configuration makes it possible in particular to move the two shank legs relative to each other, in particular to bend them, and in this way to obtain a particularly good fixation of the milling chisel in a chisel holder. The material recess obtained with the clamping slot means that the milling chisel is less solid in this region. The clamping slot is therefore also preferably open toward the rear side in the direction of the longitudinal axis of the milling chisel away from the chisel tip. Overall, the clamping slot thus preferably extends as far as the rear side of the milling chisel at least in the clamping region, and in the radial direction relative to the longitudinal axis of the milling chisel on at least two opposite sides completely through the milling chisel. In this region, the two shank legs are thus preferably free of contact with each other, which facilitates a bending process for clamping purposes, for example, in such a way that the two shank legs are bent apart in a radial direction relative to the longitudinal axis of the milling chisel. This may be combined with an inclined sliding surface and/or guide recess.

The shank legs and the clamping slot may extend into the shank region of the milling chisel, in particular as far as the contact region, which is in particular conical in shape.

The dimensions of the head region, the contact region, the shank region and the clamping region may vary. With regard to the radial extension of the individual regions relative to the longitudinal axis of the milling chisel, however, the head region may have the maximum radial extension of the milling chisel. With regard to the axial extension of the individual regions along the longitudinal axis of the milling chisel, there are also numerous possible variations. Generally, however, it is advantageous if the axial extension of the contact region is greater than the axial extension of the clamping region. The ratio of the axial length of the contact region to the axial length of the clamping region is particularly preferably greater than 2:1 and very particularly greater than 3:1, especially greater than 4:1.

Spreading or bending of the at least two shank legs relative to each other can be achieved in various ways. One variant is to use a clamping means that can be adjusted separately from the milling chisel and separately from a chisel holder. In particular, a clamping screw may be used for this purpose, the function of which is essentially to cause the at least two shank legs to bend relative to each other by means of a screwing-in movement. In one embodiment of the present invention, this is achieved by the two shank legs having a receiving section which overlaps the clamping slot and is essentially hollow-cylindrical or hollow-cylindrical-shell-shaped and/or hollow-cone-shaped or hollow-cone-shell-shaped, in particular comprising a thread. The receiving section is configured to at least partially receive a clamping screw. In particular, if the receiving section has a thread or is configured as a threaded section, a clamping screw can engage positively in this thread in such a way that it bends the two opposing shank legs outward relative to each other in a radial direction relative to the longitudinal axis of the milling chisel or at least partially spreads them apart with respect to the longitudinal axis of the milling chisel during a continued screwing-in movement. This movement may be used to fix the milling chisel in a chisel holder in a manner described in more detail below.

While an optionally present thread essentially serves to guide the clamping screw or its positive engagement, at least one of the two shank legs and in particular both shank legs may additionally or alternatively have a guide recess, in particular in the form of a hollow cone shell, which is configured to guide a clamping screw for at least partial adjustment, in particular spreading apart, of the two shank legs relative to one another. The core purpose of the guide recess is to guide the clamping screw for spreading apart the two shank legs in a defined manner and thus to ensure, among other things, a defined force transfer between the clamping screw and the milling chisel.

The guide recess is preferably configured as a smooth-walled, in particular hollow cone-shaped, spreading section which adjoins the essentially hollow cylindrical and/or hollow cone-shaped threaded section in the screwing-in direction of a clamping screw.

It is advantageous if a relief bore is present, which is positioned terminally in the clamping slot or adjoins it without transition, in such a way that the distance between the two shank legs in the region of the relief bore partially increases relative to the adjacent clamping slot and then decreases, and that the two shank legs are connected to each other via a connecting region directly adjacent to the relief bore. The relief bore is thus a through bore in radial direction relative to the longitudinal axis of the milling chisel, in particular directly adjacent to the clamping slot or directly merging into it. With the aid of the relief bore, a transitional widening of the clamping slot is thus obtained toward the milling chisel part connecting the two shank legs. The relief bore thus causes a transitional material taper compared to the regions adjacent to the relief bore. The relief bore can therefore be used to reduce material stresses in this region when the two shank legs are bent relative to each other, thus preventing the occurrence of undesirable fractures, for example.

The milling chisel for a ground milling machine may thus comprise a chisel tip, in particular comprising a PCD material, an essentially cone-segment-shaped chisel cap, in particular comprising a hard metal, with a tip region in which the chisel tip is connected to the chisel cap, and a chisel base body connected to the chisel cap on the side opposite the tip or head region. Preferably, it is now possible for the chisel cap to have an at least partially conical circumferential contact surface. Further, the chisel base body has a receiving surface complementary to the at least partially conical circumferential contact surface, which contacts the circumferential contact surface. This means that the chisel cap is in direct contact with the base body. Finally, according to the present invention, the chisel cap and the chisel base body enclose a cavity, said cavity being formed such that it extends over at least 10%, in particular over at least 20% and more particularly over at least 25%, of the extension of the chisel cap in the direction of a longitudinal axis of the milling chisel. Ideally, the extension of the cavity even extends over at least 50% of the extension of the chisel cap, in each case in the direction of the longitudinal axis of the milling chisel. Thus, an appreciable cavity may be provided inside the milling chisel. With the aid of this cavity, it is possible, among other things, to achieve significant material savings, since in particular the chisel cap no longer has to be formed continuously from one side to the opposite side, but rather at least in some regions a wall region is provided which surrounds the cavity, in particular radially relative to the longitudinal axis of the milling chisel, and which delimits the internal cavity from the external environment.

The milling chisel may be configured such that the circumferential contact surface of the chisel cap is completely conical, in particular with a continuous and smooth-surfaced outer circumferential surface. In this manner, the chisel cap can be attached to the base body without any special positioning with respect to its axial rotational position relative to the base body, which facilitates installation. Additionally or alternatively, the circumferential contact surface may surround, in particular completely, the longitudinal axis of the milling chisel. This can also make it easier to install the chisel cap on the base body. Additionally or alternatively, the at least partially conical circumferential contact surface of the chisel cap may be configured to taper in the direction away from the chisel tip and in the direction toward a chisel shank. Thus, the contact cone formed by the chisel cap extends, in the direction away from the chisel tip, toward the longitudinal axis of the milling chisel. Additionally or alternatively, the cavity projects in the longitudinal direction of the milling chisel away from the chisel base body in the direction toward the chisel tip beyond the circumferential contact surface and the receiving surface. The cavity thus extends from the base body in the direction toward the chisel tip over the circumferential contact surface and the receiving surface, enabling particularly extensive material savings without, however, negatively affecting the stability of the contact region between the chisel cap and the base body.

The wall thickness of the chisel cap at the axial level of the cavity, excluding the contact region, is essentially constant or, with respect to an average wall thickness, varies at most in the range of +/−10% of the average wall thickness, the average wall thickness being the wall thickness in the region of the cavity in the radial direction relative to the longitudinal axis of the milling chisel (excluding the contact region).

During the use of the milling chisel, the chisel tip usually lifts a chip from a solid underlying ground. The chip can then slide off along the milling chisel. This movement wears out not only the chisel tip but the entire head region of the milling chisel. The radial configuration of the chisel base body relative to the longitudinal direction of the milling chisel is free of protrusions relative to the chisel cap. This means that the maximum extension of the base body in radial direction relative to the longitudinal axis of the milling chisel is at most as large as the maximum extension of the chisel cap in radial direction relative to the longitudinal axis of the milling chisel. This means that the chisel cap completely shields the chisel base body when viewed from the chisel tip. Since the chisel cap is preferably made of a material that is more wear-resistant than the chisel base body, the chisel cap also achieves at least partial wear protection for the chisel base body and in particular for the connection or contact region between the chisel base body and the chisel cap.

The cavity or its extension is of importance. With regard to the extension of the cavity in the radial direction relative to the longitudinal axis of the milling chisel, it is particularly advantageous if the maximum extension of the cavity in the radial direction is greater than 20%, in particular greater than 30% and more particularly greater than 50% of the maximum radial distance of the outer circumferential surface of the chisel cap from the longitudinal axis. Additionally or alternatively, the maximum extension of the cavity in the radial direction is less than 90%, in particular less than 80%, of the maximum radial distance of the outer circumferential surface of the chisel cap from the longitudinal axis. These size ratios have proven to be optimal for the commonly used chisel sizes. Additionally or alternatively, it is advantageous if the cavity extends in the radial direction beyond a contact cone of a chisel shank for contact with a chisel holder and/or beyond the extension of the entire chisel shank. In this manner, a particularly high material saving is achieved with simultaneously high mounting stability of the milling chisel. It may also be advantageous if the extension of the cavity in the radial direction relative to the longitudinal axis of the milling chisel is greater than the extension of the chisel tip in the radial direction relative to the longitudinal axis and/or equal to or greater than the wall thickness of the chisel cap at the same axial level of the longitudinal axis of the milling chisel.

Further variation possibilities of the milling chisel according to the present invention exist with respect to the axial longitudinal extension of the cavity in the direction of the longitudinal axis of the milling chisel. With regard to this dimensioning, it is advantageous if the ratio of the maximum axial extension of the cavity in the direction of the longitudinal axis of the milling chisel to the maximum radial extension of the cavity radially relative to the longitudinal axis is in the range of 1.5:1 to 1:1.5, in particular 1.4:1 to 1:1.4. Additionally or alternatively, the axial longitudinal extension of the cavity in the direction of the longitudinal axis of the milling chisel is less than the axial distance from a lower edge of the chisel cap in the longitudinal direction of the milling chisel to an inner wall of the milling chisel intersecting the longitudinal axis. It may also be advantageous if the ratio of the maximum axial longitudinal extension of the cavity in the direction of the longitudinal axis of the milling chisel to the maximum axial longitudinal extension of the entirety of the chisel tip and chisel cap in the direction of the longitudinal axis of the milling chisel is in the range from 1:1.5 to 1:7, preferably in the range from 1:1.7 to 1:2, and/or the maximum extension of the cavity in the direction of the longitudinal axis of the milling chisel is greater than 1/9 and in particular than ⅕ of the maximum extension of the milling chisel in the longitudinal direction of the longitudinal axis of the milling chisel. With the aid of these modified embodiments, the configuration of the cavity in the longitudinal direction can be optimized in terms of material savings and component stability.

Preferably, the milling chisel is configured such that the enclosed cavity has a volume fraction of at least 15%, in particular of at least 25% and more particularly of at least 30% of the space volume occupied by the cavity and the chisel cap together and/or that the cavity has a volume fraction of at least 5% and in particular of at least 10% of the total volume of the milling chisel and/or of at most 30%, in particular at most 25% of the total volume of the milling chisel. Additionally or alternatively, the volume of the enclosed cavity may be greater than the volume of a chisel tip body forming the chisel tip. These volume ratios also represent an optimum range in terms of stability and material savings.

With regard to the specific structural configuration of the cavity, it is further advantageous if the cavity is configured in the shape of a conical segment and/or has a smooth wall, in particular comprising a uniform conical surface and/or at least one circular bottom surface, in particular two opposing circular surfaces. Such a cavity is comparatively easy to manufacture. Additionally or alternatively, the cavity is configured such that it has an inner wall running essentially perpendicular to the longitudinal axis of the milling chisel, in particular in the form of a circular disc, and/or comprises an inner wall which intersects the longitudinal axis and is at an angle of 100° to 140°, in particular 105° to 120°, to a side wall which does not intersect the longitudinal axis and in particular surrounds the latter.

For optimum relative positioning and force transfer between the chisel cap and the chisel base body, it is preferred if the cone angle of the circumferential contact surface to the longitudinal axis in the direction of the chisel tip in a virtual plane along the longitudinal axis is in the range from 25° to 75°, in particular from 35° to 65° and more particularly in the range from 45° to 55°. The formed cone thus tapers toward the longitudinal axis, preferably in the direction away from the chisel tip. In the preferred angular range, optimum force transfer from the chisel cap to the chisel base body is achieved and, at the same time, a positioning of the chisel cap on the chisel base body that has a high load-bearing capacity.

A circumferential annular groove may be provided in the chisel base body, in particular in the radial direction in front of the contact region or on the inside of the contact region. An annular edge of the chisel cap may engage in the annular groove in the longitudinal direction of the milling chisel. On the one hand, this may also facilitate assembly and optimize an exact alignment of the chisel cap and the chisel base body. On the other hand, solder may be introduced in this region for fastening purposes.

The conical configuration of the contact region between the chisel cap and the chisel base body offers a number of advantages, especially if the chisel cap is attached to the chisel base body via a soldered connection provided in this region. A challenge with regard to the type of attachment exists in particular when the chisel base body is made of a conventional steel material, whereas the chisel cap is preferably made of a hard metal. Common hard metal materials often have a coefficient of thermal expansion that is about half that of the steel materials commonly used in milling chisels. This can lead to high shear stresses between the chisel cap and the chisel base body, especially when using soldered connections. However, if the contact region is not configured perpendicular to the longitudinal axis of the milling chisel, but is inclined relative to the longitudinal axis due to the conical shape in the contact region, so that an angle of significantly less than 90° is obtained, these shear stresses can be significantly reduced. Furthermore, the soldering is then subjected to pressure due to the oscillating direction of force during milling, which ultimately enables significantly higher forces to be transferred from the chisel cap to the chisel base body.

Another aspect of the present invention relates to a chisel holder, in particular for use with a milling chisel according to the present invention in a chisel holder system according to the present invention. A possible special feature of the chisel holder according to the present invention may be that an undercut is provided in the chisel holder, i.e., in its interior, which is provided for direct contact with a clamping wedge of a milling chisel, in particular a milling chisel according to the present invention as described above.

According to the present invention, the chisel holder may be formed essentially as a holder sleeve, with an end face-side milling chisel receiving opening, a shank receiving space adjoining the milling chisel receiving opening in the direction of an insertion axis of a milling chisel and extending into the interior of the holder sleeve, and a clamping means opening extending transversely to the insertion axis of the shank receptacle, which provides an access connection separate and locally spaced from the milling chisel receiving opening and extending from the outside of the holder sleeve surrounding the insertion axis into the interior of the chisel holder to the shank receiving and/or the clamping wedge receiving space. The inner cavity of the chisel holder, in particular the milling chisel receiving opening in the shank receiving space, may also include a conical contact space which is at least partially funnel-shaped or hollow cone-shaped with a cross-section tapering in the insertion direction. The milling chisel is inserted into the chisel holder in the insertion direction via the milling chisel holder opening. This is usually done along a linear axis, which is referred to herein as the insertion axis. Alternatively, the insertion axis may also be defined by a longitudinal axis of the chisel holder and/or by the longitudinal axis of a milling chisel inserted into the chisel holder. According to the present invention, a shank receiving space is provided in the insertion direction behind the milling chisel receiving opening. This shank receiving space is longitudinally elongated along the insertion axis and serves to accommodate the chisel shank inside the chisel holder when the milling chisel has been inserted. The clamping means opening provides access from outside the chisel holder system to the clamping region of the milling chisel transverse to the insertion axis of the shank receptacle, for example, for tightening and loosening the clamping device and/or for threading the clamping device. The fact that this clamping means opening runs transversely to the insertion axis means that it is not necessary to access the rear of the chisel holder, which is preferably closed in this case, to loosen and tighten the milling chisel in the chisel holder, for example, but this is instead possible via lateral access, so that comparatively narrow arrangements of several chisel holders are possible, for example.

The chisel holder may have a clamping wedge receiving space which adjoins the shank receiving space in the direction of the insertion axis and is configured to receive at least one clamping wedge, the clamping wedge receiving space having at least a partial region which is widened in the radial direction relative to the shank receiving space adjoining it against the insertion direction and is thus partially undercut. It has a contact surface, preferably complementary to a contact surface of a clamping wedge of an inserted milling chisel, which can be used to clamp a milling chisel in the chisel holder. For this purpose, the clamping wedge receiving space is configured to enlarge at least partially outwardly relative to the shank receiving space in the radial direction relative to the insertion axis, so that overall a cavity is obtained which is at least partially undercut relative to the shank receiving space and which can be used for positive contact of the clamping wedge of the milling chisel when the milling chisel has been inserted. The contact surface in the clamping wedge receiving space of the chisel holder preferably runs at an angle to the insertion axis in such a way that the radial distance of the contact surface from the insertion axis increases in the direction away from the milling chisel receiving opening, i.e., toward the rear. The contact surface, which is radially spaced from the insertion axis, is thus tilted in the insertion direction or to the rear.

A clamping means, in particular a clamping screw, may be used to clamp a milling chisel, in particular a milling chisel according to the present invention, in the chisel holder. In order to enable such a clamping screw to act directly on a milling chisel positioned in the chisel holder, the clamping means opening is provided according to the present invention, which connects the outside of the chisel holder with the interior of the chisel holder, more specifically the shank receiving space and/or the clamping wedge receiving space. In this manner, the clamping means can be introduced from outside the chisel holder, for example a clamping screw may be screwed in, which, in particular at least with its tip region, projects into the shank receiving space and/or the clamping wedge receiving space and there contacts a subregion of a milling chisel positioned in the chisel holder and fixes it, for example, by spreading shank legs, and/or slides along the inclined sliding surface and/or engages in the guide recess in order to trigger a pull-in force acting on the milling chisel in the chisel holder, for example, with the aid of the straight-wedge mechanism described above.

The clamping means opening in the chisel holder may have an internal thread for engagement of a corresponding external thread of the clamping means, in particular the clamping screw. In this manner, on the one hand, no thread is then required in the clamping region of the milling chisel in order to generate the above-described pull-in force. On the other hand, the chisel holder sleeve is regularly configured to be comparatively solid, so that sufficient material thickness is available to provide a sufficiently dimensioned internal thread.

The chisel holder may have a sleeve bottom with a bottom wall which closes off, in particular completely, the interior space inside the chisel holder in the insertion direction on an end face opposite the milling chisel opening. This means that the end face of the chisel holder opposite the milling chisel receiving opening is closed, so that no dirt and/or water can enter the interior of the chisel holder from this rear face, for example during operation. This concept can be advanced to the point where the chisel holder preferably has only the end face-side milling chisel receiving opening and the clamping means opening extending transversely to the insertion axis of the shank receptacle as connection openings to the outside environment of the chisel holder. In the assembled state, this results in an interior of the chisel holder that is completely sealed off from the outside environment. For improved sealing, the clamping screw may be provided with a protective cap and/or the milling chisel may have a sealing device, such as a sealing ring, in the contact region. With the aid of such a chisel holder, the interior of the chisel holder can be completely sealed off from the outside environment, thereby preventing water and/or dirt from entering the contact region between the milling chisel and the chisel holder. This effectively counteracts corrosion and/or other adverse effects that occur due to water and/or dirt in this region.

The clamping means opening may be essentially hollow cylindrical. Additionally or alternatively, it is further advantageous if the clamping means opening has a thread, in particular an internal thread.

It is advantageous if the chisel holder has a hollow cone-shaped contact region or contact space between the milling chisel receiving opening and the shank receiving space, the radial distance of which from the insertion axis at least partially decreases in the insertion direction away from the milling chisel receiving opening. This enables the use of a milling chisel with a conical contact region with improved force transfer between the milling chisel and the chisel holder and also facilitates pre-positioning of the milling chisel within the chisel holder during installation of the milling chisel in the chisel holder.

Additionally or alternatively, the clamping wedge receiving space may also at least partially be configured as a hollow cone or, in particular, comprises two hollow cone shells arranged opposite each other. The two hollow cone shells are preferably spaced apart from each other in a radial direction relative to the insertion axis via an insertion slot and taper in a radial direction relative to the insertion slot in the direction toward the milling chisel receiving opening, resulting in the undercut subregion. The at least partial configuration of the clamping wedge receiving space in the form of a hollow cone or with hollow cone shell-shaped regions provides an optimized mating surface for contact with the clamping wedge of a milling chisel inserted in the chisel holder.

The chisel holder according to one embodiment of the present invention may be provided for direct attachment to a milling tube or for accommodation by a base part connecting the chisel holder to the milling tube. In the latter case, the chisel holder is then configured as a quick-change tool holder.

For the chisel holder system according to one embodiment of the present invention, when inserted in the chisel holder, the milling chisel with its at least one clamping wedge may come into direct, and in particular force-loaded, contact in the clamping wedge receiving space of the chisel holder with the aid of the clamping device or the clamping screw for non-rotatable fixing of the milling chisel relative to the chisel holder. Tightening of the clamping screw, for example, preferably causes two shanks of the milling chisel to spread open, as described above. Due to this relative adjustment of the two shank legs, they come into direct contact with the inner surface of the clamping wedge receiving space or the corresponding contact surfaces present there, which are at least partially complementary to the contact surface of the at least one clamping wedge, so that the milling chisel is fixed directly relative to the chisel holder in the interior of the chisel holder. The contact region of the clamping wedge in the clamping wedge receiving space runs obliquely to the insertion axis of the chisel holder or obliquely to the longitudinal axis of the milling chisel, and more specifically preferably in such a way that the angle of the contact surface of the clamping wedge relative to the insertion axis of the chisel holder or to the longitudinal axis of the milling chisel in a direction away from the chisel tip is less than 90°, in particular less than 70°. However, this angle is further preferred to be greater than 20° and in particular greater than 30°. In this manner, a kind of straight-wedge mechanism is thus obtained between the clamping screw, the clamping wedge and the clamping wedge receiving space. Spreading the two shank legs then causes a resulting positioning and holding force acting on the milling chisel in the insertion direction of the milling chisel or in the direction of the longitudinal axis of the milling chisel into the interior of the chisel holder. Tightening the clamping screw thus causes the milling chisel to be pulled into the interior of the chisel holder or in the direction of the longitudinal axis of the milling chisel away from the chisel tip. The tightening force applied by the clamping device or, in particular, the clamping screw is converted into a tensile force acting on the milling chisel in the insertion direction, with which the milling chisel is pulled against the conical contact space inside the chisel holder, especially with its contact cone. This deflection of the tightening force acting on the clamping device into a tensile force acting on the milling chisel is achieved by using the wedge surfaces described above or the contact surfaces between the milling chisel and the chisel holder running obliquely to the insertion axis.

Even if the specific configuration and in particular the specific angles may be varied, there are nevertheless generally angle ranges. The contact surfaces of the contact cone of the milling chisel and of the conical contact space of the chisel holder preferably have mutually complementary circumferential surface lines relative to the longitudinal axis and/or to the insertion axis, which in the case of a virtual extension intersect the longitudinal axis of the milling chisel and/or the insertion axis of the chisel holder preferably in an angular range, determined in the direction toward the chisel tip, of greater than 5°, in particular greater than 10° and less than 50°, more particularly less than 30°. The contact surfaces of the clamping wedge of the milling chisel and in the clamping wedge receiving space of the chisel holder preferably have mutually complementary circumferential surface lines relative to the insertion axis and/or to the longitudinal axis, which in the case of a virtual extension intersect the longitudinal axis of the milling chisel and/or the insertion axis of the chisel holder preferably in an angular range, determined in the direction away from the chisel tip, of less than 75°, in particular less than 60° and/or greater than 20°, more particularly greater than 30°. The two circumferential surface lines are also preferably at an angle of 50° to 130°, in particular 60° to 120°, to each other.

The chisel holder system may also be configured as a quick-change tool holder system. An additional base part is then provided, which is configured to support the chisel holder. The base part is further configured for attachment on a milling tube.

Independent of the foregoing, another aspect of the present invention relates to a milling chisel, in particular as described above, and a milling chisel rotating tool. The milling chisel rotating tool is configured to rotate the milling chisel, in particular when it is inserted in a chisel holder, about its longitudinal axis and/or insertion axis in the chisel holder. According to the present invention, the milling chisel may have a tool engagement means in its head region, in particular in the region of its outer circumferential surface in the head region. The tool engagement means is configured such that it has a protrusion and/or recess extending radially relative to the longitudinal axis of the milling chisel and in the circumferential direction around the longitudinal axis of the milling chisel. The tool engagement means is thus a region that, when viewed in the circumferential direction around the longitudinal axis of the milling chisel, is closer to or further away from the longitudinal axis of the milling chisel in the radial direction than an adjacent region. For this purpose, for example, the chisel cap may be configured with furrows running in the direction of the longitudinal axis of the milling chisel. According to the present invention, the milling chisel rotating tool is further configured for at least partially complementary engagement in the tool engagement means such that, when the milling chisel rotating tool engages in the tool engagement means, a positive fit is achieved in the circumferential direction around the longitudinal axis of the milling chisel. For the tool engagement means, for example, there may be engagement projections and/or recesses on the milling chisel rotating tool, which in the case of several projections and/or recesses are ideally arranged eccentrically, in particular point-symmetrically to one another. Ideally, the milling chisel rotating tool has an engagement sleeve or a grip ring that has a circumferential configuration in the radial direction when the milling chisel rotating tool engages the tool engagement means of the head region of the milling chisel.

In particular, the specific configuration of the milling chisel rotating tool may be varied in many ways. For example, it is advantageous if the milling chisel rotating tool has a rotation lever projecting outward in the radial direction, in particular in the form of a handle, in order to achieve a lever transmission for facilitated execution of the rotating movement of the milling chisel. In addition, it is advantageous if the tool engagement means has multiple tool engagement means spaced at a same angular distance from each other. In this way, different placement positions of the milling chisel rotating tool on the milling chisel are possible, which facilitates the installation process. It may be advantageous if the number of tool engagement means provided in the head of the milling chisel corresponds to the total number of engagement protrusions and/or recesses provided on the milling chisel rotating tool.

Further advantageous variation possibilities exist in particular with regard to the configuration of the tool engagement means in the head region of the milling chisel. In principle, it is advantageous to integrate the tool engagement means integrally into a protective cap, i.e., the chisel cap. Additionally or alternatively, the tool engagement means may further be longitudinally elongated in the axial direction of the longitudinal axis of the milling chisel, in order to facilitate a precise placement of the milling chisel rotating tool when slid over the chisel tip.

Another aspect of the present invention relates to an assembly unit with a milling chisel according to the present invention and a clamping means, in particular with a clamping screw. The milling chisel may have an inclined sliding surface and/or a guide recess which is contacted and/or engaged by the clamping means, in particular the clamping screw. An inclined sliding surface refers to an outer surface of the milling chisel that runs obliquely to a thread axis or a rotation axis of the clamping screw, so that the continued screwing-in movement of the clamping screw along the thread axis causes a positioning force acting on the inclined sliding surface at an angle to said thread axis. A guide recess refers to a recess within the milling chisel that is configured such that it allows a defined relative movement of the clamping screw relative to the milling chisel. The clamping means may in particular be a clamping screw. The clamping screw refers to a screw element, in particular one-piece and/or longitudinally elongated, in particular with an external thread. The external thread runs around the thread axis. The purpose of the clamping screw is to fix the milling chisel in a defined position within a chisel holder described in more detail below by directly contacting the milling chisel. The clamping means and in particular the clamping screw and the milling chisel, the latter in particular in the region of the inclined sliding surface and/or the guide recess, are configured at least partially complementary to each other for this purpose.

The assembly unit may be configured such that the clamping screw has the screw thread with the thread axis, wherein the thread axis and the longitudinal axis of the milling chisel are skewed or intersect at an angle, in particular perpendicular to each other. This ensures that the clamping screw does not move parallel or coaxial to the longitudinal axis of the milling chisel when it is screwed in and out along the thread axis. In particular, this also allows the clamping screw itself to be relieved of impact forces introduced into the milling chisel during the milling process. In addition, it is then not absolutely necessary to tighten or loosen the clamping screw in a region “behind the milling chisel”, which facilitates assembly and disassembly, particularly in the case of fine milling drums with a densely equipped milling drum, as will also be described in more detail below.

The clamping screw may have a clamping cone on an end face relative to a screw axis or to the thread axis and a recess on the opposite end face for positive engagement of a screwing tool. Such a positive engagement may be, for example, a slot, a recess with a polygonal cross-section, etc. for engagement of common screwing tools, such as slot, cross recess, hexagon, etc. The clamping cone is used for direct contacting of the milling chisel, in particular for spreading apart the two aforementioned shank legs of the latter during a continued screwing-in movement. The clamping cone thus preferably has a smaller diameter throughout than the thread diameter of the screw thread of the clamping screw and is also configured such that it tapers along the thread axis in the direction away from the screw thread.

Additionally or alternatively, it may be advantageous if the clamping screw comprises a cylindrical part adjacent to the clamping cone, in which the recess for positive engagement of a screwing tool is provided at the end face, the clamping cone and/or the cylindrical part having the screw thread in the form of an external thread.

It is possible that the thread engagement of the clamping screw occurs on a chisel holder and not directly on the milling chisel. According to another embodiment of the present invention, however, the milling chisel, in particular one or both of the shank legs, may have a clamping thread for engaging the clamping screw in such a way that the radial distance of the two shank legs radially relative to the longitudinal axis of the milling chisel is at least partially increased during a continued screwing-in movement of the clamping screw.

Another aspect of the present invention relates to a milling drum, in particular a fine milling drum, with at least one chisel holder system according to the present invention. The main elements of typical milling drums are a hollow cylindrical support tube, inside which a connecting flange for a milling drum drive is arranged in a manner known per se. On the outer circumferential surface, on the other hand, a large number of chisel holder systems and optionally other elements, such as edge protectors, ejector plates, etc., are arranged. The present chisel holder system according to the present invention is particularly suitable for use on so-called fine milling drums. These drums have a comparatively dense fitting of the outer circumferential surface with chisel holder systems, so that in particular the rear side of the chisel holders is very difficult to access. Such fine milling drums preferably have line spacings of less than or equal to 8 mm. A common use for such fine milling drums is the removal of road markings and/or the milling of road surfaces to a comparatively shallow depth, for example to depths of no more than 2 cm.

The present invention also relates to a ground milling machine, in particular a cold milling machine, with a milling drum according to the present invention. Generic ground milling machines are known in the prior art and are described, for example, in DE102012022879A1, which is hereby incorporated by reference. The present invention further extends to front rotor type milling machines, center rotor type milling machines and rear rotor type milling machines.

Finally, the present invention also relates to a method for installing a milling chisel in a chisel holder. In order to avoid repetition with regard to the designations and the possible structure of the individual elements of the milling chisel, the assembly unit, the chisel holder and the chisel holder system, reference is made below to the above discussion.

According to the present invention, for installing the milling chisel in the chisel holder, a first step involves inserting the milling chisel into an interior of a chisel holder along an insertion axis up to an insertion end position. The insertion end position is reached when the milling chisel cannot be inserted further into the interior of the chisel holder along the insertion axis or in the direction of the longitudinal axis of the milling chisel. According to the present invention, a next step involves introducing at least one clamping wedge of the milling chisel into a clamping wedge receiving space located inside the chisel holder until reaching a clamping pre-position, which involves rotating the milling chisel about the insertion axis, in particular by 90°, from the insertion end position for this purpose. As a result, the clamping wedge is rotated into the clamping wedge receiving space by means of a movement perpendicular to the insertion direction. This step is of essential importance for the method according to the present invention, because such a procedure makes it possible to insert a part of the milling chisel, more specifically the clamping wedge, into the undercut receiving region of the chisel holder coming from the milling chisel receiving opening of the chisel holder in a constructively comparably simple manner. Once the clamping wedge has been rotated into the clamping wedge receiving space, a next step involves introducing a clamping means, in particular a clamping screw, into the chisel holder in such a way that the clamping means causes a clamping force acting on the milling chisel in such a way that the milling chisel reaches or is pulled into a clamping end position in which it is pressed with its at least one clamping wedge against an inner wall of the clamping wedge receiving space of the chisel holder and, at the same time, is pulled into the chisel holder until making contact via a contact region adjoining a head region or is subjected to a pull-in force at least in this pull-in direction.

The inserting of the clamping means, in particular the clamping screw, into the clamping wedge receiving space within the clamping wedge receiving space may result in a spreading apart in radial direction relative to a longitudinal axis of the milling chisel of at least two shank legs spaced apart from each other in radial direction via a clamping slot, or in a generating of a pull-in force acting on the milling chisel in the insertion direction of the milling chisel into the chisel holder, in particular with the aid of an inclined sliding surface and/or guide recess, especially in the chisel shank. With regard to the configuration of the clamping slot and the shank legs spaced from each other in the radial direction, the inclined sliding surface and/or the guide recess, reference is made to the above explanations. Thus, for example, said spreading occurs at least almost perpendicular to the longitudinal axis of the milling chisel.

Additionally or alternatively, introducing of the clamping means may be performed along a rotation axis that is skewed or transverse, in particular perpendicular, to the insertion axis of the milling chisel in the milling chisel holder.

### BRIEF DESCRIPTION OF THE DRAWINGS

The present invention will be explained in more detail below by reference to the embodiment examples shown in the figures; wherein:

FIG. 1A shows a top view of a fine milling drum;

FIB. 1B shows a side view of the fine milling drum of FIG. 1A;

FIG. 2A shows a top view of another milling drum;

FIG. 2B shows a side view of the milling drum of FIG. 2A;

FIG. 3A shows an exploded view of a chisel holder system;

FIG. 3B shows a side view of the milling chisel of FIG. 3A;

FIG. 3C shows a side view of the milling chisel of FIG. 3A rotated by 90° about the longitudinal axis of the milling chisel in relation to the side view of FIG. 3B;

FIG. 3D shows a top view of the tip of the milling chisel of FIG. 3A;

FIG. 4A shows a cross-sectional view through the chisel holder system of FIG. 3A;

FIG. 4B shows a side view of the milling chisel of FIG. 3A rotated by 90° about the longitudinal axis of the milling chisel in relation to the cross-sectional view of FIG. 4A;

FIG. 5A shows the cross-sectional view of FIG. 4A with the milling chisel fixed in the chisel holder;

FIG. 5B shows the cross-sectional view of FIG. 4B with the milling chisel fixed in the chisel holder;

FIG. 6 is a flowchart of a method according to the present invention;

FIG. 7 shows a side view of a ground milling machine;

FIG. 8 shows an enlarged detail view of the region 48 of FIG. 5A;

FIG. 9A shows an oblique perspective view of an exploded view of an alternative embodiment of a chisel holder system;

FIG. 9B shows an oblique perspective view of the chisel holder system of FIG. 9A with the milling chisel fixed in the chisel holder and with an installation tool;

FIG. 9C shows a longitudinal cross-sectional view through the chisel holder system of FIGS. 9A and 9B with the milling chisel half inserted into the chisel holder;

FIG. 9D shows a longitudinal cross-sectional view rotated by 90° about the longitudinal axis or insertion axis compared to the longitudinal cross-sectional view in FIG. 9C;

FIG. 9E shows a longitudinal cross-sectional view through the chisel holder system of FIGS. 9A to 9D with the milling chisel in the rotated end position;

FIG. 9F shows a top view into the interior of the chisel holder of FIGS. 9A to 9E;

FIG. 9G shows a cross-sectional view transverse to the longitudinal axis or insertion axis along line III-III of FIG. 9E with the milling chisel in the insertion end position;

FIG. 9H shows a cross-sectional view transverse to the longitudinal axis or insertion axis along line III-III of FIG. 9E with the milling chisel in the rotated end position.

FIG. 10A shows an oblique perspective view of an exploded view of a further alternative embodiment of a chisel holder system;

FIG. 10B shows a longitudinal cross-sectional view through the chisel holder system of FIG. 10A with the milling chisel in the insertion end position;

FIG. 10C shows the longitudinal cross-sectional view of FIG. 10B with the clamping means tightened in the chisel holder and the milling chisel clamped; and

FIG. 11 shows a longitudinal cross-sectional view along the longitudinal axis according to an alternative embodiment of a milling chisel.

### DETAILED DESCRIPTION OF THE INVENTION

Like components are designated by like reference numerals in the figures, although recurring components may not necessarily be designated throughout the figures.

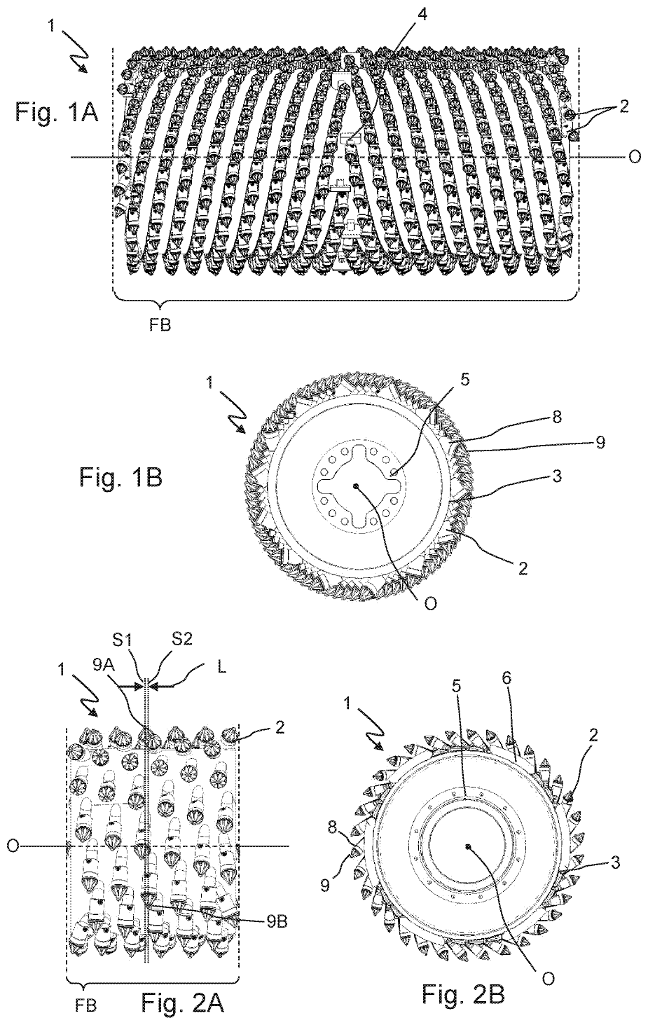

FIG. 1A shows a milling drum 1 in a top view and FIG. 1B in a side view. In milling operation, the milling drum rotates about the rotation axis R, for example, driven by a suitable milling drum drive (not shown), for the connection of which a suitable drive flange 5 may be provided on the milling drum 1. An essential element of the milling drum 1 is a hollow-cylindrical support tube 3 (also referred to as a milling tube), the outer circumferential surface of which is occupied by a plurality of chisel holder systems 2. The chisel holder systems 2 each comprise a chisel holder 8 and a milling chisel 9. The chisel holder 8 may be directly attached to the outer circumferential surface of the support tube 3, as shown in the figures, or may be positioned and retained as a quick-change tool holder in a base member not shown, which in turn is directly connected to the support tube. FIG. 1A illustrates an arrangement of the chisel holder systems 2 in such a way that they run in helices directed toward the center of the milling drum. The side view of FIG. 1B illustrates that the individual chisel holder systems 2 are offset in the circumferential direction around the rotation axis R and are ideally arranged with gaps in between.

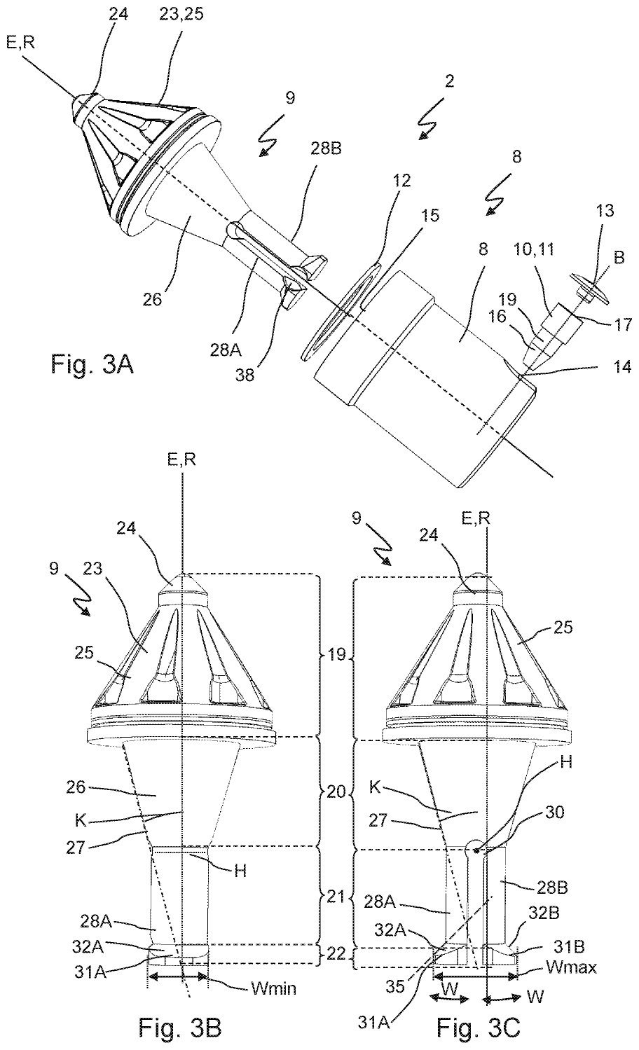

FIGS. 2A and 2B also show a milling drum 1, wherein in this milling drum 1, on the one hand, the milling width FB, i.e., the extension of the milling drum 1 along the rotation axis O, is smaller compared to the embodiment example according to FIGS. 1A and 1B. In addition, the arrangement of the chisel holder systems 2 differs from the previous embodiment in that there is no helical arrangement directed toward the center of the milling drum 1, but rather an arrangement in rows continuous over the entire milling drum width FB. However, the side view according to FIG. 2B also shows that the individual chisel tips of the chisel holder systems 2 are likewise arranged with gaps in between and offset to each other in the circumferential direction.

FIGS. 1A to 2B further illustrate that milling drums 1 may have additional elements on their outer circumferential surface in addition to the chisel holder systems 2, such as so-called ejectors 4 and/or edge protectors 6.

Further, the milling drums 1 of FIGS. 1A to 2B are so-called fine milling drums. These are characterized by a comparatively high density of chisel holder systems 2 on the outer circumferential surface of the milling drum 3. This results in small line distances, with a line distance denoting the distance in the axial direction of the rotation axis R of two adjacent cutting circles, as illustrated in more detail in FIG. 2A. FIG. 2A shows two milling chisels 9A and 9B adjacent to each other in the axial direction of the rotation axis. The chisel tips of these milling chisels 9A and 9B, which are not designated per se in FIG. 2A, each generate a cutting circle about the rotation axis O during rotation operation. The position of the two cutting circles in the direction of the rotation axis is marked 51 and S2 in FIG. 2A. The distance between these two cutting circles 51 and S2 in the direction of the rotation axis O is called the line spacing L. In fine milling drums, for example, this line spacing L is less than or equal to 8 millimeters.

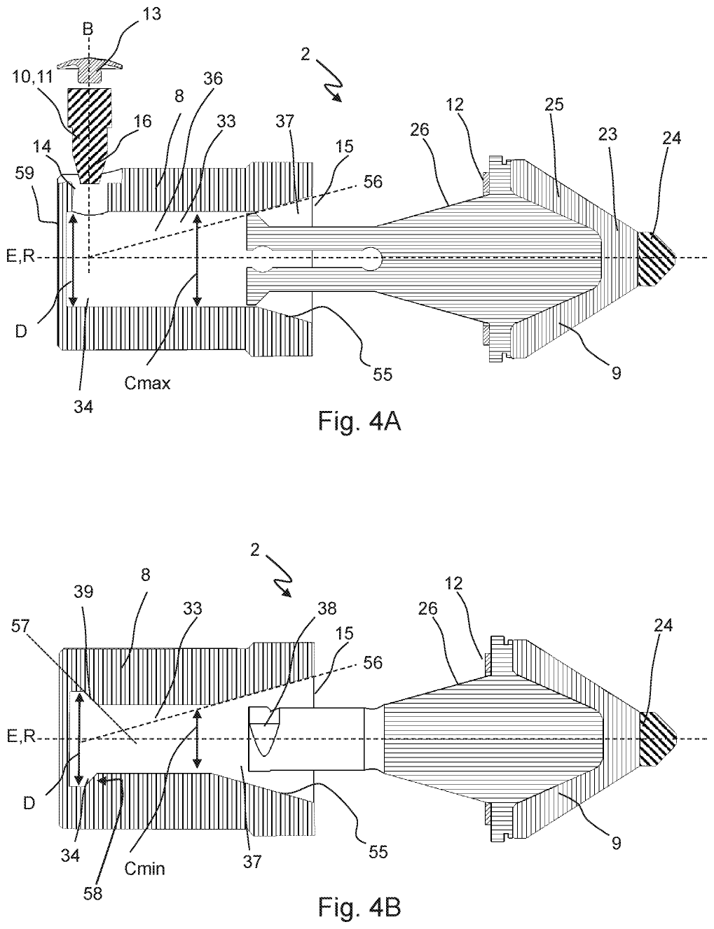

FIG. 3A shows an exploded view of an embodiment example of a chisel holder system 2. The main components here are the chisel holder 8 and the milling chisel 9. In addition, a clamping means 10 is provided, in this case in the form of a clamping screw 11. The chisel holder system 2 may further comprise a sealing ring 12 and/or a sealing cap 13.

The milling chisel 9 can be inserted into the chisel holder 8, in particular along an insertion axis E, which, as in the present embodiment example, may correspond to a longitudinal axis R of the milling chisel 9. The longitudinal axis A of the milling chisel 9 corresponds to its longitudinal extension. The milling chisel 9 may be rotationally symmetrical and/or point-symmetrical with respect to said longitudinal axis A. The insertion axis R designates a movement axis along which the milling chisel can be inserted in a straight line from the position shown in FIG. 3A to an insertion end position in the chisel holder 8, for example, as part of an installation process when replacing the milling chisel. For this purpose, the chisel holder 8 has a milling chisel receiving opening 15 provided on the end face side in the direction of the insertion axis R, which is adjoined by an internal cavity not shown in FIG. 3 within the chisel holder 8, which in the present embodiment is configured as a holder sleeve, in particular comprising a shank receiving space and a clamping wedge receiving space. In the direction of the insertion axis R opposite the milling chisel opening 15, on the other hand, the chisel holder 8 is preferably closed and may have a sleeve bottom 59 for this purpose, for example.

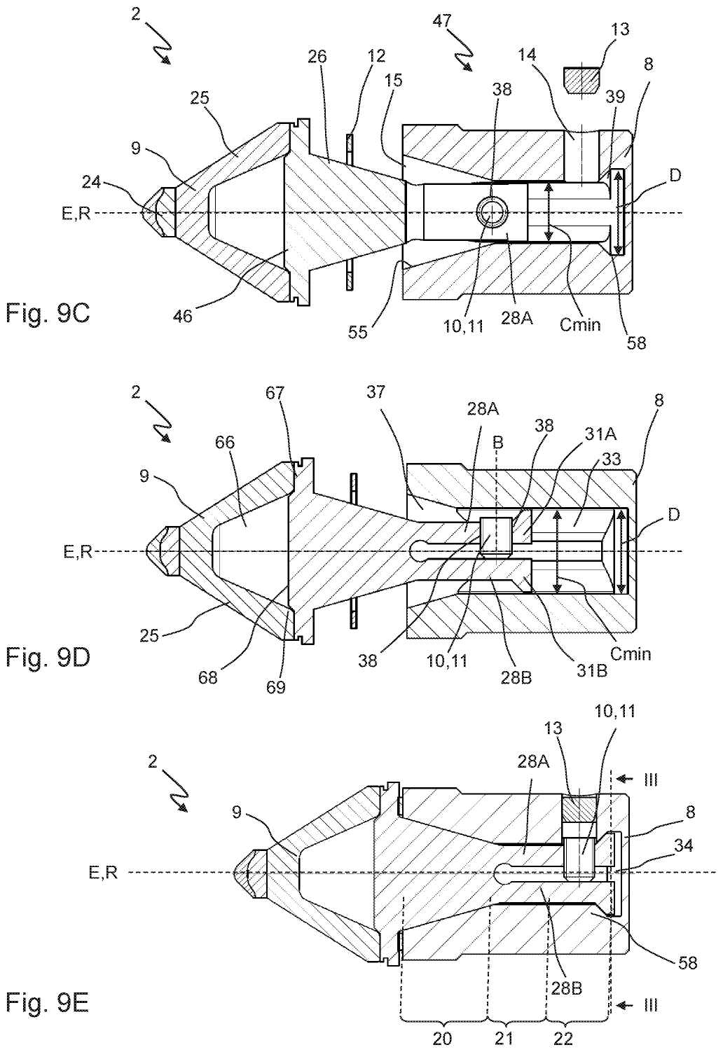

The clamping means 10 in the present case refers to a device with the aid of which the milling chisel 9 can be fixed or clamped directly with respect to the chisel holder 8. The clamping means 10 can be inserted into the chisel holder 8 from the outside, in particular in such a way that it directly and immediately contacts the milling chisel 9 located in the chisel holder 8 or comes into positive engagement with it. For this purpose, a clamping means opening 14 is provided in the chisel holder 8, which can establish a connection between the cavity located inside the chisel holder 8 for receiving parts of the milling chisel 9 and the outside environment of the chisel holder 8 separate from the milling chisel receiving opening 15. A clamping means 10 may be the clamping screw 11 shown in FIG. 3A. However, other clamping devices may also be used. The clamping means 10, in particular the clamping screw 11, may have a clamping cone 16, in particular on an end face of a screw-in or longitudinal axis B, which is tapered toward a tip. In particular, the clamping cone 16 may be conical, especially with a rectilinear or uncurved cone surface or with an elliptical-paraboloidal cone surface. The clamping means 10 and in particular the clamping screw 11 may further comprise, on the side opposite the tip of the clamping cone 16, a part, in particular of cylindrical shape, with a recess 17 for tool engagement. The recess enables positive engagement of a screwing tool, for example in the form of a hexagon, a cross recess, etc. A shank part 18 may be provided between the recess 17 and the clamping cone 16 along the screw-in or longitudinal axis B of the clamping screw into the chisel holder 8 and/or the milling chisel 9. Said shank part may be cylindrical or also cone-shaped. Furthermore, threads, in particular screw threads, may be provided on the outer circumferential surface of the clamping cone 16, of the part carrying the recess for tool engagement 17 and/or of the shank part 18, which are provided for engagement in a suitable mating thread in the manner described below (in particular according to FIG. 8) as, for example, part of the clamping means opening 14 and/or of the milling chisel 9. The thread axis is coaxial with the screw-in or longitudinal axis B. Generally, various specific configurations of the clamping device 10 and in particular of the clamping screw 11 may be used. However, it has proved advantageous for the clamping screw 11 to be configured as a set screw, for example.

FIGS. 3B and 3C illustrate further details of the specific configuration of the milling chisel 9. The view in FIG. 3C is a view rotated by 90° about the longitudinal axis E compared to the view in FIG. 3B, and perpendicular to the longitudinal axis of the milling chisel 9. The relationship of the viewing directions is illustrated in more detail in FIG. 3D. FIG. 3B in this case corresponds to the side view from viewing direction II in FIG. 3D and FIG. 3C corresponds to viewing direction I of FIG. 3D.

In the present embodiment, essential elements of the milling chisel 9 are, for example, in immediate succession along the longitudinal axis E, a head region 19, a contact region 20 adjoining said head region in the direction away from the chisel tip, a shank region 21 adjoining said contact region in the direction away from the chisel tip, and a clamping region 22 adjoining said shank region in the direction away from the chisel tip. The individual regions are designated in more detail with regard to their respective axial extension in the direction of the longitudinal axis E in FIG. 3B and FIG. 3C. It should be emphasized that the ratios of the axial lengths of the individual sections to one another may vary. However, it is advantageous, as also shown in the present embodiment example, if the contact region 20 is larger in its axial extension than the clamping region 22 with respect to its axial extension, in particular by at least a factor of two and more particularly by at least a factor of 2.5. This applies regardless of the present embodiment example.

The head region 19 of the milling chisel 9 comprises a chisel head 23 with a chisel tip 24, which is tapered in the direction toward a chisel tip 24. The chisel head 23 may further include a chisel cap or wear protection cap 25. FIGS. 3B and 3C illustrate that the chisel head 23 is essentially configured in such a manner that it widens radially with respect to the longitudinal axis E in a direction away from the chisel tip 24 along the longitudinal axis E of the milling chisel. In other words, at least essential parts of the chisel head are preferably configured essentially as a cone, which also includes variants that have surface deformations in the head region, such as slot-like recesses, etc. In its entirety, the head region 19 essentially designates that part of the milling chisel 9 in the axial direction of the longitudinal axis E which is in direct contact with the ground material during milling operation, whether for milling or forwarding.

In contrast, the contact region 20 directly adjoining the head region 19, for example, designates that region of the milling chisel 9 which is essentially provided for, in particular direct, contact with the chisel holder 8, in particular in the interior of the milling chisel holder 8 in the direction of the insertion axis R behind the milling chisel receiving opening 15 (as explained in more detail below), and is functionally responsible in particular for the transfer of force from the milling chisel 9 to the chisel holder 8. In terms of its radial extension, this region is therefore also preferably smaller or narrower than the maximum radial extension of the head region 19 and recedes behind the latter in the radial direction. In particular, the contact region 20 may at least partially include a contact cone 26. The latter may be configured as a straight truncated cone with a linear circumferential surface line and a cone axis running coaxially to the longitudinal axis E, as illustrated in more detail by way of example in FIGS. 3B and 3C. In this case, the contact region 20 may be configured such that the contact cone 26 extends over essentially the entire contact region 20 in the direction of the longitudinal axis E. In particular, the outer circumferential surface of the contact cone 26 may extend at an angle K in a range of 5° to 50° and more particularly in a range of 10° to 30° to the longitudinal axis E of the milling chisel 9. Curved or otherwise deformed circumferential surface lines are also conceivable, as long as a section is obtained in which the milling chisel tapers away from the chisel tip 24 without transition and ideally evenly or continuously, as is the case with a cone, instead of tapering abruptly. In particular, the abrupt step between the head region and the contact region provided in the embodiment example, by which the radial extension of the milling chisel 9 is greatly reduced, is not part of the contact region. One aspect of the contact region according to the present invention is that it allows contact not only in the axial direction but also simultaneously in the radial direction, as is the case, for example, with the cone included in the embodiment example. This applies generally to configurations of a milling chisel according to the present invention and is not to be understood as being limited to the present embodiment example.

In the shank region 21 adjoining the contact region 20 along the longitudinal axis of the milling chisel 9 toward the rear, on the other hand, the milling chisel may be of essentially cylindrical design, in which case there may be two shank legs 28A and 28B in this region, which are spaced apart from one another in the radial direction via a clamping slot 29. The two shank legs 28A and 28B both end in the contact cone 26.

At the end of the clamping slot 29 located in the direction of the chisel tip 24, this slot may merge into a relief bore 30 running perpendicular to the longitudinal axis E. The relief bore 30 may be partially widened relative to the width of the clamping slot 29, i.e., the direct radial spacing of the two shank legs 28A and 28B, so that, as shown by way of example in the present embodiment example, a region of lower material thickness is obtained in the region of the relief bore 30 compared to the thickness of the two shank legs 28A and 28B in the radial direction. The relief bore 30 may be hollow-cylindrical. The longitudinal axis H of the relief bore 30 runs, for example, radially with respect to the longitudinal axis E of the milling chisel 9 and intersects it. Bending forces acting on the shank legs 28A and 28B, in particular in the direction of the shank legs 28A and 28B in or against the radial direction relative to the longitudinal axis E, therefore result in a defined relative movement on the one hand of the two shank legs 28A and 28B to each other and also relative to the rest of the milling chisel 9, in particular relative to the contact region 20. The bending movement thus obtained is indicated by the arrows P in FIG. 3C.

The shank region 21 may be essentially cylindrical in shape, interrupted only by the clamping slot 29. In particular, the diameter of the shank region 29, i.e., the distance of the outer circumferential surface of the shank legs 28A and 28B from the longitudinal axis E of the milling chisel 9, may be constant.

In a direction away from the chisel tip 24, the shank region 21 may be directly adjoined by the clamping region 22 along the longitudinal axis E. In the clamping region 22, as shown in the present embodiment, the milling chisel 9 may have, for example, two clamping wedges 31A and 31B, each on one of the two shank legs 28A and 28B. The clamping wedges 31A, 31B may partially protrude beyond the outer circumferential surface of the shank region 21 in a radial direction relative to the longitudinal axis E and may each have a wedge-shaped contact surface 32A, 32B in this region. The contact surfaces expand in the radial direction along the longitudinal axis E away from the chisel tip, i.e., increase with respect to their radial distance. The clamping wedges 31A and 31B thus each represent a wedge-shaped protrusion relative to the shank region 21, extending in a radial direction relative to the longitudinal axis E of the milling chisel 9. The clamping wedges 31A and 31B are not formed circumferentially around the longitudinal axis E of the milling chisel 9, but alternately in a segment-like manner in the circumferential direction around the longitudinal axis E. This means that, viewed in the circumferential direction, the radial extension of the clamping region 22 alternates between a maximum radial extension Wmax and a minimum radial extension Wmin. The shank region 21 and the adjoining clamping region 22 of the milling chisel 9 are thus essentially T-shaped overall. The minimum radial extension Wmin may correspond to the maximum diameter of the shank region 21. It is essential that at least one clamping wedge 31 is provided in the clamping region 22, which protrudes in radial direction relative to the longitudinal axis E or insertion axis R relative to the shank region 21. The protrusion obtained with the aid of the at least one clamping wedge 31 may be used in a manner described in more detail below to clamp the milling chisel 9 to the chisel holder 8 in a manner according to the present invention.

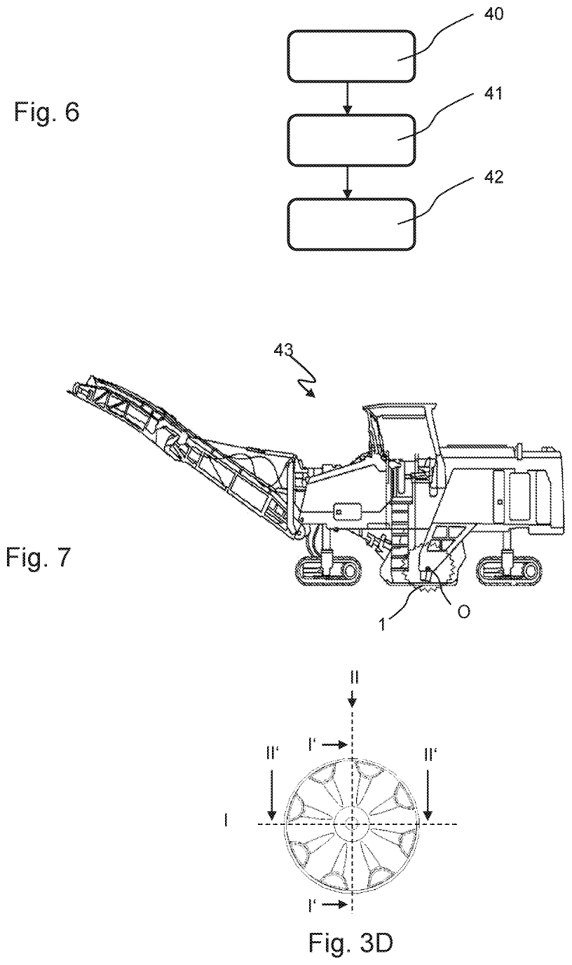

The clamping wedges 31A and 31B or at least the at least one clamping wedge 31 comprise the contact surface 32 extending obliquely to the longitudinal axis E with a circumferential surface line 35 which extends in particular at an angle G (FIG. 5B) in a range of greater than 20°, in particular greater than 35°, and/or smaller than 70°, in particular smaller than 55°, in the present embodiment, for example, approx. 45°, to the longitudinal axis E of the milling chisel 9. The radial distance of the outer circumferential surface of the respective clamping wedge from the longitudinal axis E increases in the direction away from the chisel tip 24 of the milling chisel 9. Overall, the milling chisel 9 thus comprises in the contact region 20 and in the clamping region 22 two contact surfaces extending, in a direction away from the chisel tip 24 of the milling chisel 9, in a wedge shape or in a counter-directional manner and obliquely to the longitudinal axis E (indicated in particular by the course of the circumferential surface lines 27 and 35), so that the milling chisel 9 as a whole has a constriction which at least partially surrounds the longitudinal axis E of the milling chisel and which may be formed by the contact cone 26 and the at least one clamping wedge 31 or the clamping wedges 31A and 31B. These two wedge-shaped contact surfaces, arranged one behind the other in the direction of the longitudinal axis E of the milling chisel 9 away from the chisel tip 24, are used in the manner described in more detail below to clamp the milling chisel 9 directly to the chisel holder 8.

The milling chisel 9 may further have an inclined sliding surface and/or guide recess 38, particularly in the region of the milling chisel shank and more particularly in the region of the shank legs 28A and 28B, which is provided for at least partial engagement with the clamping means 10. The purpose of this inclined sliding surface and/or guide recess 38 is, in particular, to apply a clamping force to the clamping region 22. Exemplary for this is the guide recess 38 (FIG. 3A) illustrated in the embodiment examples of FIGS. 3A to 3D, which is hollow cone-shaped and extends over the clamping slot 29 between the two clamping wedges 31A and 31B. In the specific embodiment example, two cone-shell-shaped recesses, which are located opposite and mirror-symmetrical to each other, are arranged for this purpose at the level of the clamping wedges 31A and 31B, which in their entirety form the guide recess 38 and which are provided for engagement of the clamping means 10. When the clamping device 10 is driven into this guide recess 38, this causes the two shank legs 28 to spread apart in the direction of arrow W (FIG. 3C).

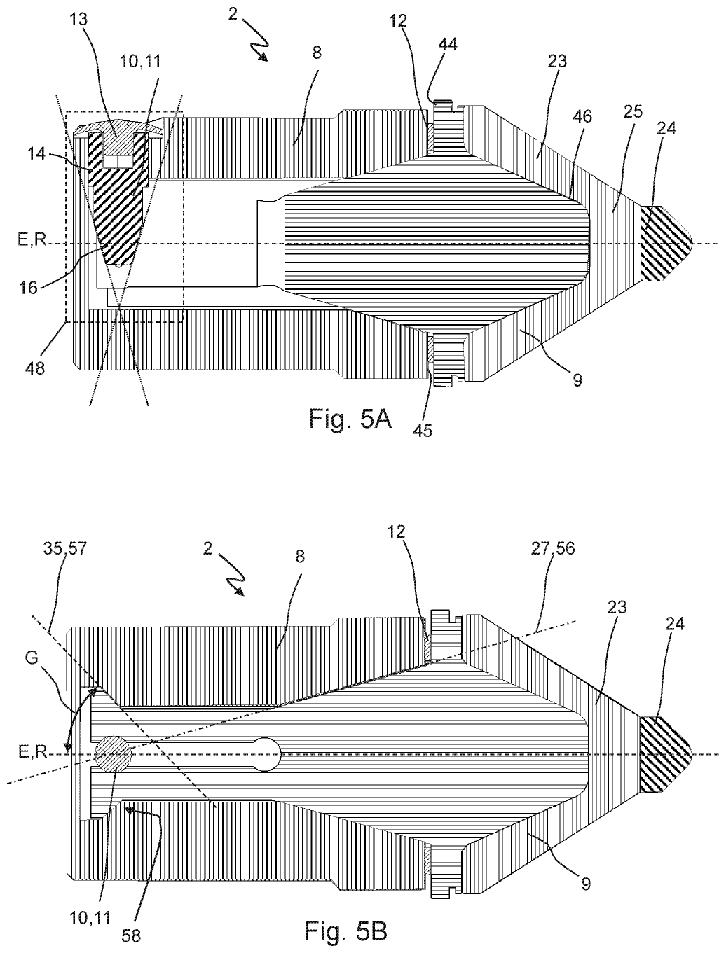

The operating principle of the exemplary chisel holder system 2 described above is explained in more detail, in particular, by the cross-sectional views of FIGS. 4A, 4B, 5A and 5B. All of these figures represent longitudinal cross-sectional views through the milling chisel holder system 2 along the insertion axis R or longitudinal axis E, as shown in the exploded view of FIG. 3A. FIGS. 4A and 4B show a condition in which the milling chisel 9 is partially inserted into the chisel holder 8. In FIGS. 5A and 5B, on the other hand, the milling chisel 9 is in its end position, in which it is in a position clamped with the chisel holder 8. In FIG. 4A, the milling chisel holder system 2 is shown in a cross-sectional view according to section line II′, and in FIG. 4B it is shown in a cross-sectional view according to section line I′ of FIG. 3D. In FIGS. 5A and 5B, the milling chisel 9 is rotated relative to the chisel holder 8 by 90° about the insertion axis R and the longitudinal axis E, respectively. With respect to the chisel holder 8, FIG. 5A thus corresponds to section line II′ and FIG. 5B corresponds to section line I′ of FIG. 3D.

The chisel holder 8 may be configured as an essentially cylindrical sleeve having the milling chisel receiving opening 15 and a clamping means opening 14. The interior of the chisel holder 8 is marked 36. In the present embodiment example, said interior is preferably accessible exclusively from outside the chisel holder 8 via the milling chisel receiving opening 15 and the clamping means opening 14. In the direction of the insertion axis R, a conical contact space 37, a shank receiving space 33 and a clamping wedge receiving space 34 may successively adjoin the milling chisel receiving opening 15 within the chisel holder 8 in the interior space 36. The conical contact space 37 is at least partially complementary to the contact cone 26 of the milling chisel 9 and at least partially has a hollow cone-shaped or funnel-shaped inner circumferential surface which, in a direction away from the chisel receiving opening 15, tapers radially relative to the insertion axis R along the latter in a linear manner. The clamping wedge receiving space 34 has an essentially circular cross-section in a radial direction relative to the insertion axis R with a diameter D. In contrast, the shank receiving space 33 has a cross-section shaped as a rounded rectangle with a maximum diameter Cmax and a minimum diameter Cmin perpendicular thereto. The maximum diameter Cmax, for example, corresponds essentially to the diameter D in the clamping wedge receiving space 34. The minimum diameter Cmin, on the other hand, is smaller than both the maximum diameter Cmax and the diameter D in the clamping wedge receiving space 34. Thus, an undercut 58 is obtained overall in the clamping wedge receiving space 34 with respect to the shank receiving space 34, into which the at least one clamping wedge 31 or the clamping wedges 31A and 31B described above for the present embodiment example can be rotated for clamping the milling chisel 9 with respect to the chisel holder 8. The maximum diameter Cmax of the shank receiving space 33 is therefore also selected at least such that it is larger, ideally as minimally as possible, than the maximum extension Wmax of the milling chisel 9 in clamping region 22. The minimum diameter Cmin of the shank receiving space 33, on the other hand, is dimensioned such that it is smaller than the maximum radial extension Wmax of the clamping region 22 but at the same time, ideally as minimally as possible, larger than the minimum radial extension Wmin of the clamping region 22 of the milling chisel 9.

In the direction of the insertion axis E, the chisel holder 8 is closed at the end face on the side opposite the milling chisel receiving opening 15. Apart from the additionally provided clamping means opening 14, the receiving space inside the chisel holder 8 is thus essentially configured as a blind hole. The chisel holder 8 may comprise a total of exclusively two openings to the outside environment, via which the interior, in particular comprising the delimitation by the contact surface 55 for the contact cone 26 of the milling chisel 9, or the interior defined by this contact surface, or the conical contact space 37, the shank receiving space 33 and the clamping wedge receiving space 34, is connected to the outside environment.

The contact surface 55 with the circumferential surface line 56 is at least partially and in particular completely complementary to the contact region 26 or its circumferential surface line 27 (FIG. 5B). In contrast, the contact surfaces 39 in the clamping wedge receiving space 34, in particular with the circumferential surface line 57 (FIG. 4B), are formed at least partially complementary to the corresponding contact surfaces of the at least one clamping wedge 31 or of the two clamping wedges 31A and 31B of the milling chisel 9 (FIG. 5B).

Overall, as a comparison of FIGS. 4A and 4B in particular makes clear, the chisel holder 8 in the present embodiment example may, on the one hand, have a continuous constant radial extension in the shank receiving space 33 and in the clamping wedge receiving space 34 with respect to the insertion axis R of the chisel holder 8, as shown in FIG. 4A. Rotated by 90° about this insertion axis R, on the other hand, a radial constriction or tapering of the inner cavity of the chisel holder 8 may be provided, i.e., the radial width of the interior of the chisel holder 8, starting from the milling chisel receiving opening 15, initially tapers down to the minimum diameter Cmin and then widens again to the diameter D. This provides an undercut 58 in the clamping wedge receiving space 34, which can be used to clamp the milling chisel 9 in the chisel holder 8.

In the present embodiment example, the clamping means opening 14 is essentially hollow-cylindrical in shape and connects the interior 36 relative to the insertion axis R approximately at the level of the clamping wedge receiving space 34 on one side with the outside environment of the chisel holder 8 in the radial direction relative to the insertion axis R and thus perpendicular to this axis. With the aid of the clamping means opening 14, the clamping means 10 can thus be inserted transversely and in particular perpendicularly to the milling chisel receiving opening 15 and thus from the side of the chisel holder 8 in such a way that it projects at least with a tip region into the interior 36 and in particular at least partially into the clamping wedge receiving space 34 of the chisel holder 8.

Due to the above-described relative dimensioning on the one hand of the shank region 21 and the clamping region 22 of the milling chisel 9 and on the other hand of the shank receiving space 33 and the clamping wedge receiving space 34 of the chisel holder 8, the milling chisel 9 can thus only be inserted into the chisel holder 8 in two positions rotated by 180° to each other. If the milling chisel 9 is pushed further into the chisel holder 8 along the insertion axis R from the position shown in FIGS. 4A and 4B until the contact cone 26 rests against the inner circumferential surface of the conical contact space 37 of the chisel holder 8, it reaches its insertion end position. The milling chisel 9 then cannot be inserted further into the chisel holder 8 along the insertion axis R.

Following this, the milling chisel can be rotated about the insertion axis R by approximately 90° in order to rotate the at least one clamping wedge 31, more specifically the two clamping wedges 31A and 31B in the present embodiment example, into the undercut region 58 of the clamping wedge receiving space 34 of the chisel holder 8. Due to this rotating movement, the clamping wedges 31A and 31B, viewed in the direction of the insertion axis R, overlap the above-described taper between the shank receiving space 33 and the milling chisel receiving opening 15 or, viewed in the direction of the insertion axis R toward the chisel tip 24, engage behind the undercut 58, whereby a positive locking or blocking of the milling chisel 9 in the chisel holder 8 is obtained. Accordingly, the milling chisel 9 cannot be pulled out of the chisel holder 8 from this rotational position.

The chisel holder system 2 may further comprise a rotary stop acting between the milling chisel 9 and the chisel holder 8. Said rotary stop ensures that the milling chisel 9 moves from the insertion end position to its rotated end position in a defined manner. However, this may also be ensured additionally or alternatively by the mere fact that the clamping means 10 can only fix the milling chisel 9 in a defined position of the milling chisel relative to the chisel holder. This is the case, for example, if there is a thread on the milling chisel 9 into which the clamping means is to engage for clamping the milling chisel 9, in particular for spreading apart shank legs.

As a result of the above-described rotating movement, the guide recess 38 of the milling chisel 9 comes into a relative position opposite the clamping means opening 14 of the chisel holder 8, in particular in the radial direction relative to the insertion axis R. This allows the clamping means 10 to be introduced from outside the chisel holder 8 and to engage in the guide recess 38. Due to the cone-like configuration of the tip region of the clamping means 10 or the clamping screw 11, which is described in more detail below, continued penetration of the clamping means into the guide recess and thus in particular also into the region between the two shank legs results in the two shank legs 28A and 28B being pressed apart relative to each other. The clamping wedges 32A and 32B are thus both pressed away from each other simultaneously in the direction of arrow W, i.e., in the radial direction relative to the insertion axis. The force acting in the insertion direction of the clamping device 10 is thus converted into a spreading force that is essentially perpendicular to it. The spreading movement causes the contact surfaces 32A and 32B of the clamping wedges 31A and 31B within the clamping wedge receiving space 34 to be pressed against the contact surfaces 39 of the clamping wedge receiving space 34, which extend obliquely to the insertion axis R and are at least partially essentially complementary thereto. The shape of this contact surface 39, which is oblique to the rotation axis or the insertion axis R, ultimately enables this spreading force to be converted into a tensile force acting on the milling chisel 9 in the direction of the insertion axis R into the interior of the chisel holder 8. As a result, the milling chisel 9 is pulled further into the chisel holder 8 along the insertion axis R, i.e., the contact cone 26 is pulled with a clamping force against the inner circumferential surface 55 of the conical contact space 37 of the chisel holder 8. The milling chisel 9 thus pulls itself directly against the chisel holder 8 into a fixed, non-rotatable clamping end position. In this position, the milling chisel is non-rotatably fixed in the chisel holder 8 and is ready for milling operation.

Variations with regard to the configuration of the chisel holder system 2 described above according to the present invention are also possible with regard to the configuration of the engagement of the clamping means 10 in the chisel holder 8 and/or in the milling chisel 9. Various exemplary alternatives to this are explained in more detail with reference to the enlarged region 48 of FIG. 5A shown in FIG. 8. In the region of a screw head 49, which in particular may also have the recess 17 for tool engagement, the clamping means 10 configured as a clamping screw 11 may have an essentially cylindrical outer circumferential surface 50, which may be smooth-walled or in particular may also at least partially have an external thread (designated T1 in FIG. 8 as an example). This external thread has the thread axis running coaxially to the screw-in axis B. For this case, a suitable internal thread (also part of T1 in FIG. 8) may be provided in the region of the clamping means opening 14 of the chisel holder 8. This region is designated 51 in FIG. 8. In this case, the clamping means 10 thus engages the chisel holder 8 via a threaded engagement. Additionally or alternatively, the clamping means may have a cylindrical region offset in the longitudinal direction of the clamping means 10 from the screw head 49 toward the screw tip 53, for example, with a reduced diameter relative to the screw head 49 with respect to the one screw axis B. This region 52 may be smooth-walled or, at least partially, have an external thread (designated T2 in FIG. 8 as an example). The clamping means may further have, additionally or alternatively, in particular in the region of the clamping means tip 53 or in a region 54 forming the clamping means tip 53, a conical spreading cone section tapering in particular away from the recess 17 or the screw head 49. In other words, the tip is preferably cone-shaped. Said cone may also be smooth-walled or at least partially formed with an external thread (designated T3 in FIG. 8 as an example). For regions 51 and/or 54 of the clamping means 10, in particular of the clamping screw 11, regions 55, 56 of at least partially complementary configuration may be provided in the milling chisel 9, in particular at the level of the clamping region 22, which are configured for engagement by the regions 51 and/or 54 (and for this purpose may have, for example, complementary threads or at least thread sections). In this case, the region 55 is a hollow-cylindrical-shell-shaped recess in the facing region of the shank legs 28A and 28B. The region 56 is a hollow-cone-shell-shaped recess in the facing region of the shank legs 28A and 28B. Both the region 55 and, additionally or alternatively, the region 56 may thus at least partially have internal threads or internal thread sections extending around the screw-in axis B, which are provided at least partially complementary with respect to the corresponding mating thread(s) T2 and T3 in the regions 51 and/or 54 on the clamping means 10. The interaction of the regions 51 and/or 54 of the clamping means 10 with the regions 55 and/or 56 of the milling chisel 9 results in the thread engagement between the clamping means 10 and the milling chisel 9 in this case.

In particular, FIG. 5A illustrates the function of the sealing element or sealing cap 13. The latter is placed on the clamping device or clamping means from outside the chisel holder 8 and spans, in a hood-like manner, the clamping means 10 or its head region accessible from outside the chisel holder, shielding it from the outside environment. This prevents signs of wear on the clamping means 10 or prevents dirt and grime from clogging an existing opening for engagement of a screwing tool, such as a polygonal recess.

FIG. 5A further illustrates the operating principle of the sealing ring 12. Said sealing ring may extend annularly around the longitudinal axis E and/or the insertion axis R. It is clamped in the axial direction of the insertion axis E between a contact surface 44 of the chisel holder 9 extending in the radial direction relative to the insertion axis R and a mating contact surface 45 of the chisel holder 8 located at the level of the milling chisel receiving opening 15, or surrounding it, and extending in the radial direction relative to the insertion axis R. In this manner, the sealing ring 15 achieves a sealing effect, in particular for the milling chisel receiving opening 15, which in the present embodiment example is closed in particular by the milling chisel 9. The sealing ring 12 now improves this seal to the effect that an ingress of dirt particles and/or moisture, in particular into the gap between the milling chisel 9 and the chisel holder 8, is drastically reduced.

The cross-sectional views according to FIGS. 4A to 5B further illustrate an elementary structure of the milling chisel 9. In particular, it may comprise a base body 46 acting as a tie rod, more particularly a steel base body, especially a quenched and tempered steel base body, for example, made of spring steel, which as one solid piece preferably forms the complete contact region 20, including the contact cone 26, the shank region 21 and the clamping region 22, as well as an inner part of the head region 19. The head region 19 further preferably comprises a wear protection hood or chisel cap 25 placed on the base body 46. Said cap is connected to the base body 46 by brazing, for example, and forms an essentially conical wear protection structure on the outside which forms at least essential parts of the outer surface of the head region 19. In particular, the chisel cap 25 may be made of a hard metal to effectively counteract any wear that occurs. The chisel tip may be formed by the chisel cap 25. However, it is also possible to place a chisel tip 24 on the chisel cap 25 which differs in terms of material. This preferably concerns a chisel tip 24 having a PCD (polycrystalline diamond) material. Said chisel tip may in particular be connected to the chisel cap 25 by a soldering process, especially brazing. The above-described elements 46, 25 and 24 are thus firmly and non-detachably connected to one another, so that the milling chisel 9 as a whole constitutes a one-piece overall structure.

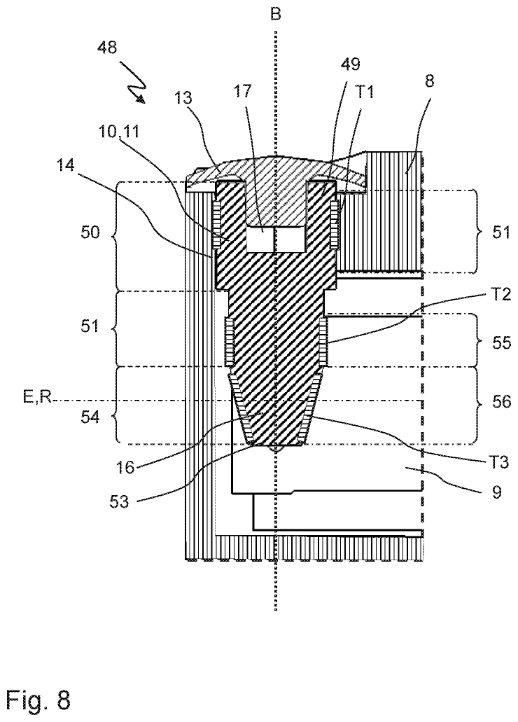

FIG. 6 now illustrates essential steps of a method according to the present invention for installing a milling chisel in a chisel holder. For the specific configuration of the milling chisel and the chisel holder, reference is also made in particular to the above-described exemplary configuration of the milling chisel 9 and the chisel holder 8 and the related disclosure.

An initial step 40 includes inserting the milling chisel into an interior of the chisel holder along an insertion axis. This can also be seen, for example, in FIGS. 3A, 4A and 4B. The milling chisel is inserted until reaching an insertion end position. The insertion end position thus designates the position in which the milling chisel cannot be inserted further along an insertion axis into the chisel holder. This end position may be achieved, for example, by a contact cone of the milling chisel contacting an at least partially complementary hollow cone-shaped contact surface within the interior of the chisel holder.

The insertion movement, in particular along the insertion axis R, is now followed by inserting the at least one clamping wedge of the milling chisel into a clamping wedge receiving space located inside the chisel holder according to step 41. This may be done in particular by rotating the milling chisel about the insertion axis R, in particular by at least approx. 90°, in order to rotate the clamping wedge into the clamping wedge receiving space. This brings the milling chisel into a clamping pre-position relative to the chisel holder, from which a subsequent introducing of a clamping means causes fixing of the milling chisel in the chisel holder according to step 42.

During said introducing of the clamping means according to step 42, in particular by screwing in a clamping screw as clamping means, a clamping force is exerted by the clamping means on the milling chisel. The clamping force causes the milling chisel to reach a clamping end position in which it is pressed with its at least one clamping wedge against an inner wall of the clamping wedge receiving space and, at the same time, is pulled into the chisel holder until contacting the chisel holder with a contact region adjoining the head region. The clamping force acting on the milling chisel with the aid of the clamping means serves in particular to produce a spreading apart of at least two shank legs, which are spaced apart from each other in the radial direction via a clamping slot, within the clamping wedge receiving space in radial direction relative to a longitudinal axis of the milling chisel. In particular, the spreading movement is perpendicular to the screw-in direction of the clamping device relative to the milling chisel. A screw-in axis along which the clamping means is screwed into the chisel holder and/or the milling chisel preferably runs obliquely or transversely, in particular perpendicularly, to the insertion axis of the milling chisel into the milling chisel holder.

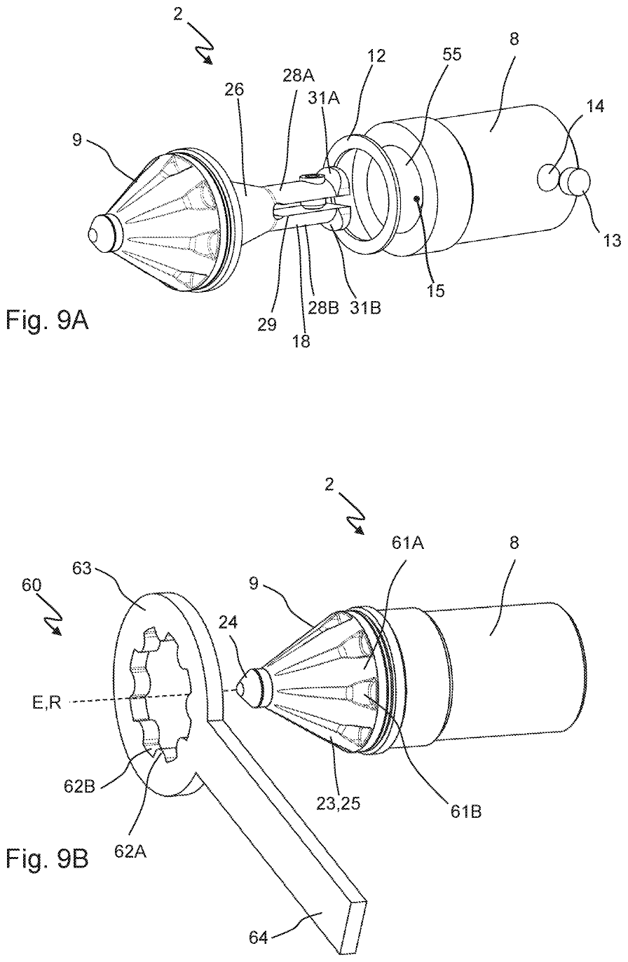

Finally, FIG. 7 shows a ground milling machine 43, in the present embodiment example a cold milling machine, which is used for removing road pavements and/or road markings in the context of roadway rehabilitation. Such machines are known per se in the prior art. They comprise a milling drum 1 arranged within a milling drum box, which in working operation is rotatable about a rotation axis R running horizontally and transversely to the working direction A. Details of the configuration of such a milling drum have already been given for FIGS. 1A to 2B.

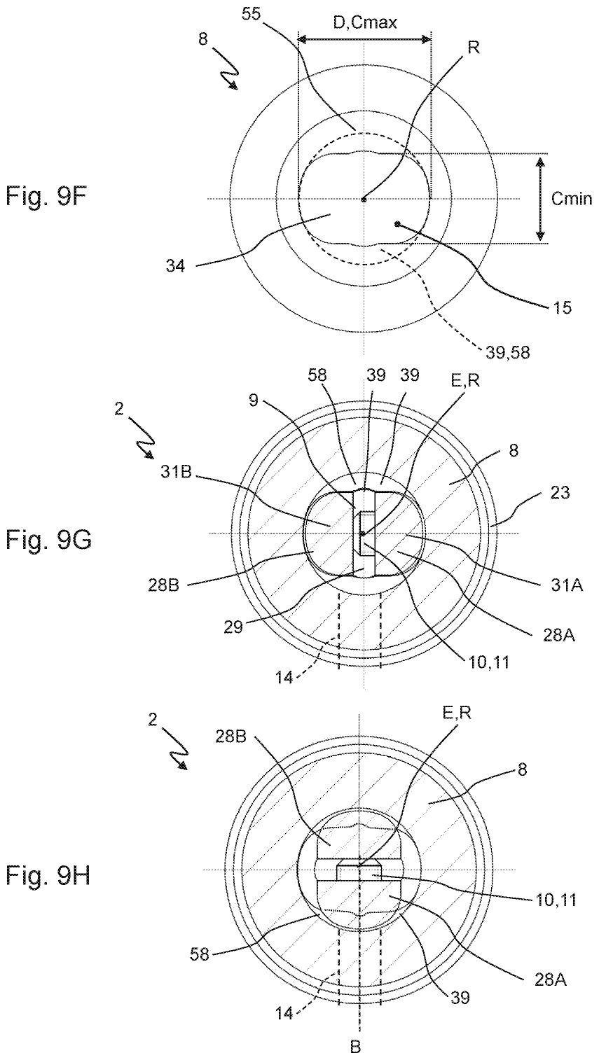

FIGS. 9A to 9H illustrate a further embodiment example of a chisel holder system 2 according to the present invention. In particular, the existing differences from the previously described embodiment example are highlighted below. In all other respects, reference is made to the explanations regarding the preceding embodiment example, in particular according to FIGS. 3A to 5B and 8.

The main difference in this embodiment example is an alternative configuration of the guide recess 38, which in this embodiment example does not extend between two shank legs 28A and 28B, but rather extends through the shank leg 28A and directed toward the second shank leg 28B. For this purpose, the clamping means opening 14 in the chisel holder 8 may have an internal thread for engagement of the clamping means 10, in particular the clamping means screw 11. Preferably, however, the guide recess 38 for positive engagement located entirely in the first shank leg 28A has an internal thread complementary to an external thread located on the clamping means screw 11. Further preferably, no internal thread is provided in the region of the clamping means opening 14 of the chisel holder 8. When the clamping means screw 11 is tightened, the two shank legs 28A and 28B are thereby subjected to a clamping force in opposite directions and are thus pressed apart in opposite directions in the radial direction relative to the longitudinal axis E and/or insertion axis R. If the chisel holder 8 does not have an internal thread in the clamping means opening 14, it cannot wear out even over several generations of milling chisels. Such a chisel holder 8 can therefore be used for comparatively long periods of time.

This embodiment also has the advantage that the clamping screw 11 can be inserted into the chisel holder 8 in an assembly in which it is already screwed into the first shank 28A and thus in a pre-assembled state, as shown, for example, in FIG. 9A. This means that the clamping screw 11 does not have to be subsequently passed through the clamping means opening 14 of the chisel holder 8. In this embodiment, the clamping means opening 14 serves as a passage for a suitable screwing tool. This greatly facilitates the process of replacing the milling chisel 9.

FIGS. 9C, 9D and 9E summarize in chronological order the installation process of the milling chisel in the chisel holder 8. Together with the clamping screw 11, these form an assembly unit 47, which may also be traded as a whole in this form. With regard to the viewing perspective, the longitudinal view of FIG. 9C is rotated by 90° compared to the longitudinal view of FIG. 9D. With regard to the viewing perspective, FIG. 9C corresponds to section line II′ of FIG. 3D and FIG. 9D corresponds to section line I′ of FIG. 3D. In particular, FIG. 9D illustrates that the clamping means 10 is dimensioned with respect to its axial extension in the direction of its screw-in axis B in such a way that it is free of protrusions with respect to the maximum radial extension of the clamping wedge 31A. The radial interior diameter Cmin is accordingly larger than the axial extension of the clamping means 10. During the insertion of the milling chisel 9 into the chisel holder 8, the screw-in axis B and the clamping means opening 14 thus run in different radial directions with respect to the longitudinal axis E and/or insertion axis R. In FIG. 9E, after the milling chisel 9 has been pushed into its insertion end position, it is rotated by 90° relative to the chisel holder 8, whereby the clamping means 10 or the screw-in axis B comes into alignment with the clamping means opening 14. If the clamping means 10, in particular the clamping screw 11, is now further tightened in the direction toward the shank leg 28B, the clamping means 10 presses the second shank leg 28B and the first shank leg 28A (provided that an internal thread is provided there in which the clamping means 10 engages) apart in radial direction relative to the longitudinal axis E and/or insertion axis R and thus presses the two clamping wedges 31A and 31B radially into the clamping wedge receiving space 34. The contact surfaces 32A and 32B of the clamping wedges 31A and 31B, which are oblique relative to the longitudinal axis E and/or insertion axis R (as already described above), thus come into contact with the at least partially complementary contact surfaces 39 of the undercut 58. In this manner, a pulling effect is exerted on the milling chisel 9 in the insertion direction of the same into the chisel holder 8 and thus the milling chisel 9 is fixed with its contact cone 26 in the clamping region 22 in the chisel holder 8.

FIGS. 9F, 9G and 9H further illustrate this effect and the configuration of the chisel holder 8. The top view of the interior of the chisel holder 8 according to FIG. 9F first illustrates the configuration of the insertion opening for the milling chisel 9 in the form of a rounded rectangle with the maximum diameter Cmax and, perpendicular to this, the minimum diameter Cmin of the shank receiving space 33. Dashed lines in FIG. 9F further indicate the radial circumference of undercut 58. Said undercut surrounds the longitudinal axis E and/or insertion axis R in a circular manner and, in the region of the minimum diameter Cmin of the shank receiving space 33, forms a free space that undercuts the shank receiving space 33 in a radial outward direction relative to the longitudinal axis E and/or insertion axis R. The clamping wedges 31 are rotated into this free space in the manner described above, as further illustrated by a comparison of FIGS. 9G and 9H. Both figures show a cross-sectional view transverse to the longitudinal axis E and/or insertion axis R along section line III of FIG. 9E. In FIG. 9G, the milling chisel 9 is in the insertion end position. In FIG. 9H, on the other hand, starting from FIG. 9G, the milling chisel is rotated by 90° about the longitudinal axis E and/or insertion axis R and is accordingly in its clamping end position (in particular with the clamping screw 11 tightened). For further clarification, FIGS. 9G and 9H show the clamping means opening 14 concealed by the chisel holder 8 in those views, and the course of the screw-in axis B.

Generally, it is further possible for the shank receiving space 33 to have one or more insertion guides, for example threading grooves 65, extending in particular parallel to the longitudinal axis E and/or insertion axis R. These guides may be longitudinal expansions introduced into the shank receiving space 33, in which a complementary region of the milling chisel 9 can positively engage. The insertion guides, in particular threading grooves 65, extend in this case, for example, from the conical contact space 37 through the entire shank receiving space 33 or only through the entire shank receiving space in the axial direction relative to the longitudinal axis E and/or insertion axis R. This can ensure, for example, that the milling chisel 9 can be inserted into the chisel holder 8 exclusively from a rotational position relative to the chisel holder 8. This can facilitate proper alignment, particularly of the clamping means opening 14 relative to the clamping means 10 and/or the guide recess 38. This is achieved by the positive non-rotatable fixing about the longitudinal axis E and/or insertion axis R achieved with the aid of the insertion guide.

FIG. 9B further shows a milling chisel rotating tool 60, with the aid of which in particular the rotary movement of the milling chisel 9 about the insertion axis R and/or the longitudinal axis E for penetration of the clamping wedge or wedges 31, 31A, 31B into the region of the undercut 58 can be facilitated. For this purpose, the milling chisel rotating tool 60 is configured for positive engagement with the head region 19 of the milling chisel 9, wherein the positive engagement is to be provided in the circumferential about the insertion axis R and/or the longitudinal axis E. For this purpose, one or more protrusions 61A and/or recesses 61B may be provided in the outer circumferential surface of the chisel head 23, in particular of the chisel cap 25. In the region of a protrusion 61A, the outer circumferential surface is offset outward in the radial direction relative to the insertion axis R and/or the longitudinal axis E relative to a recess 61B, in particular at the same axial level relative to E and/or R. Protrusion 41A and recess 61B thus form one or more steps in the circumferential direction relative to the insertion axis R and/or the longitudinal axis E. The protrusions 61A and/or recesses 61B may taper with respect to their maximum radial extension along the insertion axis R and/or the longitudinal axis E in the axial direction toward the chisel tip.

The milling chisel rotating tool 60 may include at least one engagement protrusion and/or recess 62A, 62B. The at least one engagement protrusion and/or recess 62A, 62B is a device configured for at least partially complementary engagement with the tool engagement means, in particular comprising at least one protrusion 61A and/or recess 61B. The engagement takes place in such a way that a positive fit is achieved in the circumferential direction about the longitudinal axis E and/or insertion axis R of the milling chisel 9 when the milling chisel rotating tool engages the tool engagement means. For this purpose, the milling chisel rotating tool 60 may have an annular tool region 63, on the inner circumferential ring surface of which the engagement protrusions 62A and engagement recesses 62B are arranged alternately and circumferentially, in particular at a same angular distance from one another. The angular distances are preferably complementary to the angular distances of the protrusions 61A and recesses 61B arranged alternately around the chisel tip 23. Coming from the chisel tip 24, the milling chisel rotating tool 60 can thus be pushed onto the chisel head 23, in particular the chisel cap 25, so that it engages around the chisel head 23 from the outside, the engagement protrusions 62A engaging in the recesses 61B for this purpose and the engagement recesses 62B engaging around the protrusions 61A. As a result, a plurality of positive fits are obtained in the circumferential direction relative to the insertion axis R and/or the longitudinal axis E.

To facilitate rotational movement of the milling chisel rotating tool 60, it may include a rotation lever 64 adjoining the tool region 63 and protruding therefrom to one side. Here, too, however, a variety of alternative modified embodiments are conceivable. In particular, the tool region 63 may also be formed, for example, by a tool sleeve or the like, for example, to enable a rotary drive via a motor-driven actuator, for example pneumatic, hydraulic or electric.

Another general possibility for the construction of the milling chisel 9, which is independent of the structure and mode of operation of the present chisel holder system 2, is also illustrated in more detail in particular in FIGS. 9C, 9D and 9E. The special feature is that a cavity 66 is provided between the chisel cap 25, which is preferably made of a hard metal comprising, inter alia, tungsten carbide and/or cobalt as a component, and the base body 46, which is connected to the chisel cap 25 and in particular also comprises the chisel shank, as described above. This cavity may be surrounded exclusively by the chisel cap 25 and the base body 46. Thus, the chisel cap 25 is in direct contact with the base body 46 essentially via an annular contact surface 67 (and not over the entire surface). This immediate contact region between the chisel cap 25 and the base body 46 may preferably be used to solder these two components together. It is also possible to use boron nitride, for example, either in the chisel tip or the chisel cap.

In order to ensure correct relative alignment of the chisel cap 25 to the base body 46, in particular during the manufacturing process, a positioning aid 68 may preferably be provided on the base body 46. The positioning aid 68 may be configured such that it brings causes an unambiguous relative alignment of these two components with respect to one another, acting in a positive-fitting manner in the radial and/or axial direction with respect to the insertion axis R and/or the longitudinal axis E. In the present embodiment example, for example, a chamfer 69 is provided for this purpose, which runs around the insertion axis R and/or the longitudinal axis E on the base body 46 on the outer surface facing the chisel cap 25, in particular in an annular manner. The chamfer 69 has a circumferential surface conically tapering toward the chisel tip, which facilitates centering in the sense of pre-adjustment of the chisel cap 25 relative to the base body 46.

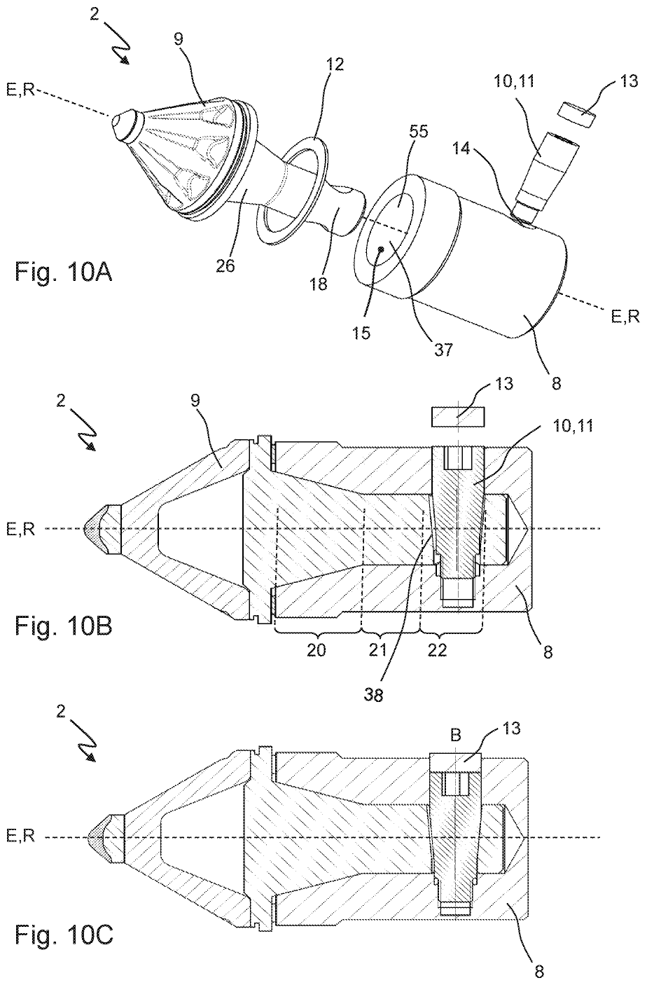

FIGS. 10A, 10B and 10 C illustrate another embodiment example of a chisel holder system 2 according to the present invention. In particular, the existing differences from the previously described embodiment examples are highlighted below. In all other respects, reference is made to the explanations regarding the preceding embodiment examples, in particular according to FIGS. 3A to 5B and 8 as well as 9A to 9H.

The special feature of the embodiment example shown in FIGS. 10A, 10B and 10C is that, in contrast to the previous embodiment examples, no clamping wedge is provided on the milling chisel 9 and thus no clamping wedge receiving space with a corresponding undercut is provided in the chisel holder. In the shank part 18, on the other hand, a bore is provided in the clamping region 22, in particular in the form of a through bore, which corresponds functionally to the guide recess 38. To fix the milling chisel 9 in the chisel holder 8, the milling chisel 9 is inserted into the chisel holder 8 along the insertion axis R and/or the longitudinal axis E until it reaches its insertion end position. The milling chisel 9 is now rotated to a position in which the guide recess 38 comes into an aligned position with respect to the clamping means opening 14 located in the chisel holder 8. After that, the clamping means 10, for example cone-shaped, is inserted into the clamping means opening 14 from outside the chisel holder 8. This can be done to the extent that the clamping means 10 completely passes through the chisel shank along the screw-in axis B and enters an internal thread located in the interior of the chisel holder 8 opposite the clamping means opening 14, which may, for example, be part of a blind hole or even a bore open to the outside. Additionally or alternatively, the clamping means opening 14 may likewise have an internal thread for threaded engagement by the clamping means 10. It is now essential that the guide recess 38 is configured, for example, as a conical through bore whose longitudinal axis or conical axis runs obliquely and, in particular, radially relative to the insertion axis R and/or longitudinal axis E. When the clamping device 10 is screwed in, the clamping device sliding on the inside of the guide recess 38 causes a tensile force on the milling chisel 9 via this cone recess, via which the contact cone 26 is pulled against the conical contact surface of the conical contact space 37.

It is possible to provide this embodiment example with shank legs 28 in the manner already described above. However, it is also possible to use a continuous shank and thus to dispense in particular with the provision of a clamping slot 29.

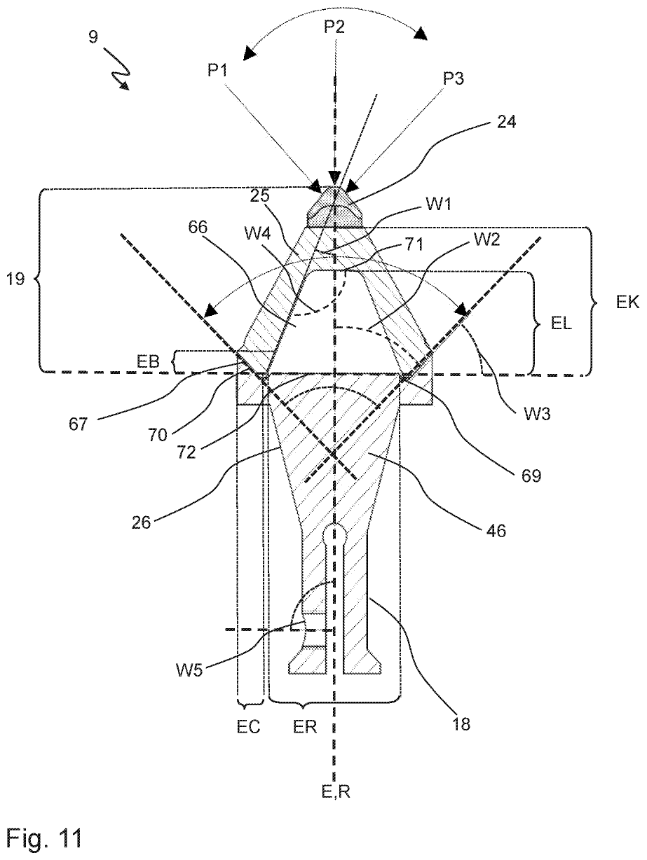

FIG. 11 illustrates another aspect of the present invention concerning the configuration of the chisel cap 25 and the base body 46. In this embodiment of the present invention, the cavity 66 may be enclosed by the chisel cap 25 and the base body 46. This cavity takes up a relatively large proportion of the volume of the milling chisel 9 and is intended to also be present as a hollow volume during milling operation of the milling chisels 9. In particular, the total volume of the cavity 66 significantly exceeds solder reservoirs used in the connection of two metal parts. The cavity 66 is actually hollow and not filled by any solid material. The cavity has an extension EL in the direction of the longitudinal axis E of the milling chisel 9 and an extension ER in the radial direction relative to the longitudinal axis E of the milling chisel 9. The radial extension ER becomes smaller from the maximum radial extension ER formed at the bottom of the cavity 66 by the axial lower end of the base body toward the chisel tip, since the frustoconical radial outer wall of the cavity formed by the chisel cap is inclined relative to the longitudinal axis E of the milling chisel by an angle W1 which is preferably smaller than 35°, in particular smaller than 30°, irrespective of the specific embodiment example. Regardless of the specific embodiment example, the maximum radial extension ER of the cavity 66 is greater than the extension EL of the cavity 66 in the direction of the longitudinal axis E. In the direction toward the chisel tip, or upward, the cavity 66 is delimited by a head roof 71 formed by the chisel cap 25. In the direction of the longitudinal axis E away from the chisel tip, or downward, the cavity is delimited by a bottom region 72 formed by the chisel base body 46. The head roof 71 and the bottom region 72 may both be circular disc-shaped and run parallel to one another. The angle W4 between the cone-shaped inner circumferential surface of the cavity 66 and the essentially planar head roof is preferably greater than 90°, particularly preferably greater than 100° and/or less than 150°, preferably less than 140°.

The chisel cap 25 has an extension EK in the direction of the longitudinal axis E of the milling chisel 9. The cavity 66 is now formed with such a spatial extension that it extends with its axial extension EL over at least 50% of the axial extension EK to the chisel cap.

The present embodiment example further shows a configuration of the contact region between the chisel cap 25 and the chisel base body 46. In contrast to the radially planar configuration of the contact region, as shown in the preceding FIGS. 9C to 9E, the contact surface between these two elements is preferably complementarily conical in shape. For this purpose, in its end region facing away from the chisel tip, the chisel cap has a radially outer circumferential contact surface 67 in the form of a cone, which is oriented at an angle W2 in the direction toward the chisel tip and completely uniformly surrounds the longitudinal axis and tapers away from the chisel tip in the direction of the longitudinal axis E. Complementary to this, the base body has a receiving surface 70 in its outer region in the radial direction relative to the longitudinal axis E, which, in a direction away from the chisel tip to the rear, tapers in a cone or funnel shape toward the longitudinal axis E. In this manner, a positive lock is obtained between the chisel cap and the chisel base body, which acts in the radial direction relative to the longitudinal axis E and is complementary to each other in the direct contact region, which not only facilitates assembly, but at the same time enables particularly efficient transfer of forces introduced into the chisel tip during milling operation, as shown here with the arrows P1, P2 and P3.

The contact region between the chisel cap 25 and the chisel base body 46 comprises an axial extension EB in the direction of the longitudinal axis E of the milling chisel 9. Toward the chisel tip, this region EB is overhung by the cavity, i.e., the cavity protrudes beyond the region EB in a direction toward the chisel tip. The radial extension EC of the contact region may be configured, as shown in FIG. 11, such that the contact region is located outside in the radial direction relative to the contact cone 26.

Another important feature of the embodiment shown in FIG. 11 is the optional configuration of the chisel cap 26 such that it projects beyond the complete chisel base body in the radial direction relative to the longitudinal axis E of the milling chisel or at least ends flush with it. In this manner, the chisel cap effectively protects the region of the milling chisel coming from the chisel tip and in the direction of the longitudinal axis E.

In the transition region between the bottom surface 72 and the receiving surface 70 or the contact region between the chisel cap 25 and the chisel base body 46, the chisel base body comprises a depression relative to the bottom surface 72 in the form of an annular groove 73. This annular groove 73, which runs around the longitudinal axis E, makes it easier to install the protective cap 25 on the chisel base body, preferably by means of a soldering process.

In the above-described contact region between the chisel cap 25 and the chisel base body 46, the chisel cap 25 is preferably attached to the chisel base body by means of a soldered connection.

What is claimed is:

1. A chisel holder system, comprising:
a milling chisel;
a chisel holder; and
a clamping device, the milling chisel, comprising:
a chisel head with a chisel tip, the chisel head widening in a head region away from the chisel tip along a longitudinal axis (E) of the milling chisel in a radial direction relative to the longitudinal axis (E);
a contact region adjoining the head region and configured to contact the chisel holder;
a shank region adjoining the contact region; and
a clamping region adjoining the shank region,
wherein the milling chisel has at least one of the following features in the clamping region:
at least one clamping wedge with a chisel holder contact surface; or
two shank legs which are spaced apart from each other in the radial direction relative to the longitudinal axis (E) of the milling chisel via a clamping slot; or
an inclined sliding surface contacted by the clamping device and/or a guide recess in which the clamping device engages, the chisel holder, comprising:
an end face-side milling chisel receiving opening;
a shank receiving space adjoining the milling chisel receiving opening in the direction of an insertion axis (R) of the milling chisel and extending into the interior of the chisel holder; and
a clamping device opening extending transversely to the insertion axis (R) of the shank receptacle, which provides an access connection from the outside of the chisel holder surrounding the insertion axis (R) to the receiving space and through which the clamping device can be inserted for fixing the milling chisel within the chisel holder.

2. The chisel holder system according to claim 1,
wherein the milling chisel has at least one of the following features:
the at least one clamping wedge has a greater radial extension (W) relative to the longitudinal axis (E) of the milling chisel than the shank region adjoining the at least one clamping wedge;
the contact region has at least partially a contact cone tapering radially in a direction away from the chisel tip, the contact cone being formed in particular as a truncated cone;
the at least one clamping wedge is arranged terminally in the longitudinal direction (E) of the milling chisel;
the at least one clamping wedge has a contact surface extending obliquely to the longitudinal axis (E) of the milling chisel, the distance of the contact surface in the radial direction relative to the longitudinal axis (E) of the milling chisel increasing in a direction away from the chisel tip; or
there are two clamping wedges positioned opposite one another in the radial direction.

3. The chisel holder system according to claim 1,
wherein the clamping device is a clamping screw which has a screw thread (T) with a thread axis (B), the thread axis (B) and the longitudinal axis (E) of the milling chisel running obliquely or intersecting at an angle (W5) to one another.

4. The chisel holder system according to claim 3,
wherein the clamping screw has a clamping cone on an end face relative to a screw axis (B) and a recess on the opposite end face for positive engagement of a screwing tool.

5. The chisel holder system according to claim 4,
wherein the clamping screw comprises a cylindrical part which adjoins the clamping cone and in which the recess for positive engagement of a screwing tool is introduced on the end face, and in that the clamping cone and/or the cylindrical part has the screw thread in the form of an external thread, or in that one or both of the shank legs has a clamping thread for engagement of the clamping screw, such that the radial distance of the two shank legs radially relative to the longitudinal axis (E) of the milling chisel is at least partially increased during continued screwing-in movement of the clamping screw.

6. The chisel holder system according to claim 1,
wherein the chisel holder has a clamping wedge receiving space which adjoins the shank receiving space in the direction of the insertion axis (R) and is configured to receive the at least one clamping wedge of the milling chisel, the clamping wedge receiving space having at least one subregion which is widened in radial direction with respect to the shank receiving space adjoining it against to the insertion direction.

7. The chisel holder system according to claim 1,
wherein the chisel holder has a sleeve bottom with a bottom wall which closes off the interior space inside the chisel holder in the insertion direction (R) on an end face opposite the milling chisel receiving opening.

8. The chisel holder system according to claim 1,
wherein the chisel holder has as connection openings to the outside environment of the interior of the chisel holder exclusively the end face-side milling chisel receiving opening and the clamping device opening extending transversely to the insertion axis (R) of the shank receptacle.

9. The chisel holder system according to claim 1,
wherein the clamping device opening or the guide recess has a thread (T1).

10. A milling drum with at least one chisel holder system according to claim 1.

11. A ground milling machine, comprising a milling drum with at least one chisel holder system, the chisel holder system comprising:
a milling chisel;
a chisel holder; and
a clamping device, the milling chisel, comprising:
a chisel head with a chisel tip, the chisel head widening in a head region away from the chisel tip along a longitudinal axis (E) of the milling chisel in a radial direction relative to the longitudinal axis E;
a contact region adjoining the head region and configured to contact the chisel holder;
a shank region adjoining the contact region; and
a clamping region adjoining the shank region,
wherein the milling chisel has at least one of the following features in the clamping region:
at least one clamping wedge with a chisel holder contact surface; or
two shank legs which are spaced apart from each other in the radial direction relative to the longitudinal axis (E) of the milling chisel via a clamping slot; or
an inclined sliding surface contacted by the clamping device and/or a guide recess in which the clamping device engages, the chisel holder, comprising:
an end face-side milling chisel receiving opening;
a shank receiving space adjoining the milling chisel receiving opening in the direction of an insertion axis (R) of the milling chisel and extending into the interior of the chisel holder; and
a clamping device opening extending transversely to the insertion axis (R) of the shank receptacle, which provides an access connection from the outside of the chisel holder surrounding the insertion axis (R) to the receiving space and through which the clamping device can be inserted for fixing the milling chisel within the chisel holder.

12. The chisel holder system according to claim 1,
wherein the clamping device comprises a clamping screw.

13. The chisel holder system according to claim 1,
wherein the contact region directly adjoins the head region,
wherein the shank region directly adjoins the contact region, and
wherein the clamping region directly adjoins the shank region.

14. The chisel holder according to claim 1,
wherein the chisel holder is essentially configured as a holder sleeve.

15. The chisel holder system according to claim 3,
wherein the thread axis (B) and the longitudinal axis (E) of the milling chisel run perpendicularly to one another.

16. The chisel holder system according to claim 9,
wherein the thread (T1) is an internal thread.

17. The milling drum according to claim 10,
wherein the milling drum comprises a fine milling drum.

18. The ground milling machine according to claim 11,
wherein the ground milling machine comprises a cold milling machine.
